(19) United States
(12) Patent Application Publication
(10) Pub. No.: US 2020/0406068 A1
(43) Pub. Date: Dec. 31, 2020

(54) LANDAR EMERGENCY EVACUATION SYSTEM FOR HIGH-RISE ABODES

(71) Applicant: VALENTINE EGBEJIMBA, LAGOS (NG)

(72) Inventor: VALENTINE EGBEJIMBA, LAGOS (NG)

(21) Appl. No.: 16/280,071

(22) Filed: Feb. 20, 2019

(51) Int. Cl. A62B 1/06; A62B 1/02; A62B 1/14

(52) U.S. Cl. CPC A62B 1/06; A62B 1/14; A62B 1/02

(57) ABSTRACT

An emergency escape system for high-rise building includes a launcher installed in a launch room/station of a given floor in a skyscraper and suspended by a spring-loaded reel of cable which is counterbalanced by the weights of the launcher which has mechanisms for floor retraction and movement control incorporated to it, and a descending ride unit on a guide rail which engages with the launcher and which conveys an escapee or a load whose weight upsets the equilibrium of the two opposing forces and while the ride unit disengages from the launcher when the launcher has descended through the retracted floor, the launcher returns to the launch station to maintain the equilibrium of the weight balance, leaving the descending ride unit to continue its motion down the shaft with its human cargo/es until brought to rest by a brake system of arresting cables with or without brake linings and drums; before safely ejecting the escapee/s from the ride unit away from the shaft.

### BACKGROUND OF THE INVENTION

### (1) Field of the Invention

This invention relates to rapid evacuation systems and, more particularly to such systems as are applied to high-rise buildings and other aloft positions such as oil rigs particularly when such positions are threatened by fire, possible bomb attack and other emergencies.

### (2) Description of the Prior Art

Several inventions have been uncovered in the search for prior art, a summary of which could be drawn as follows: 1. Simple (slow) individual escape device 2. Fast individual escape device and 3. Evacuation device for multiple individuals.

The slow individual escape device generally discloses a rope wound around a spool with one end of the rope hung on a firm support on the wall of a building adjacent to a window and the free end of the rope designed to latch with a safety harness worn by an escapee. A release device is usually incorporated which the escapee uses to gradually release the rope and thus descend slowly to the ground surface or to another floor in the same building. One major disadvantage of the rope as an emergency escape device is that descending slowly hundreds of feet with it to the ground is hardly an option for the faint hearted. Another is the vagaries of deploying this system in strong winds with the real possibility of colliding with the building or any other nearby object and getting hurt. Fire raging below the launch floor and close to the path of descent of the rope could make the user to abandon the device altogether. And because the focus is individual rather than group escape it has limited use in modern-day skyscrapers where thousands of people live or work.

The other extreme discloses systems for evacuation of large-number evacuees. This category also tends to be slow, and complicated in their operation. For example, they require electricity to function and generators have to be towed to the site. And because they tend to be unwieldy with tons of cables, gearwheels and electric motors to winch escape hatches and cabins, they lack the “touch button” readiness to service delivery. Useful time is lost and turnaround is longer while deploying them to use.

The fast individual escape devices tend to be gravity based systems. One such system—the U.S. Pat. No. 6,830,126 B2—discloses a shaft with permanent magnets laid from the top of the skyscraper to the bottom of it. A rider with a backpack of permanent magnets rolls down a shaft on a guide rail while the magnetic attraction created between the backpack and the permanent magnets laid down the shaft guarantees a uniform controlled descent. The problem with this system is that it does not convincingly address the issue of conveyance of various weight categories. While some escapees will have a body mass of 50 kg, others have 150 kg. The system as configured cannot handle this variation in body mass as claimed when it comes to brake power, the reason being that the force of attraction between the back pack unit and the permanent magnets lining the shaft is same irrespective of the weight of an escapee. Heavier individuals will demand a greater amount of brake force and so this system will be dangerous if deployed as claimed. The system may possibly work for a particular weight category and to customize back packs for all weight categories will be a challenge let alone sort them during an emergency. This will be unfeasible. Furthermore, the system failed to disclose how the escapee could with haste, safely get into the shaft in the first place and manipulate his backpack to the guide rail, two hundred meters above the ground. For those experienced in handling permanent magnets, when the opposing polarities come in close contact as is the case with the system in question, the powerful magnetic flux (of attraction) makes it difficult to make the fine adjustments necessary when it comes to manipulating the rollers into their grooves. For the same reason, ejection from the system will also be difficult. Thus, useful time is lost in a situation that demands prompt action. Therefore the claim of a few seconds sequential launch cannot hold. The Rapid Escape System for Buildings has more academic than practical importance.

And so the need for a system which could rapidly evacuate those in high-rise abodes in times of emergency exists, more so in the present-day world where three thousand persons live or work in a skyscraper. It is my opinion that the era of “slow, controlled descent” as is touted by inventions presently in use is over. We are in the era of the roller coaster, the high-speed train, jet travel, and recently the hyper loop. Today, faster lifts are coming into the market to meet the ever-growing challenges of the “Cities in the sky”. Therefore emergency evacuation systems for high-rise buildings must innovate in line with the present-day realities to be truly relevant in saving lives. Unlike the single, sequential launch systems so far patented as uncovered in the prior art, the new lifesavers must simultaneously, launch a large number of persons to safety in the shortest possible time.

Therefore it is the object of this invention to provide an emergency escape system free of the limitations recited above.

The present invention satisfies the need for rapid evacuation system capable of launching large number of escapees at once in a high-speed manner from high-rise buildings or platforms. To maximize its adaptability, the present invention has a second preferred embodiment for situations where slow-descent, rather than high speed is desired.

Considering the problems that plague other systems, such as inability to evacuate a large number of persons at short interval, cumbersomeness, electricity-dependence, long turnaround, and generally the lack of “touch button” readiness to service delivery, it is the object of this invention to provide an automated high-speed emergency escape system able to launch a large number of persons at once, without electrical power.

It is also the object of the present invention to provide an emergency escape system for skyscrapers with short turnaround made possible by a unique launch mechanism and ejection capability, thereby paving way for multiple launches at short intervals, to facilitate the evacuation of a skyscraper in record time during an emergency.

Because confusion tend to reign during emergencies, more so when large number of escapees is involved, it is the further object of this invention to provide an emergency escape system which, is user-friendly and with streamlined, conveyor belt-like operation as well as touch-button readiness to service delivery.

Another object of this invention is to provide a simple, safe and cost-effective high-altitude evacuation system that will appeal to developers especially in the Third World where electricity supply is epileptic.

### SUMMARY OF THE INVENTION

The invention is made up of:

A Launcher: This comprises a spring-loaded cable(s) which hangs overhead and suspends a beam upon which are firmly attached floor retractors and floor-lock actuators. The beam has a coupling point with a descending ride unit which will disengage at a stage and descend on its own down the shaft during use. To stabilize the beam and its appendages, rollers and guide rails are incorporated to it, thereby, enabling the launcher run on the vertical guide rails affixed to the shaft wall.

Launch Pillar/Launch Column. The launch pillar is a round, square or rectangular pipe which provides the roadway for the descending ride unit. It begins at the apex of the shaft and runs down to the ejection station below with guide rails laid on it. In the first preferred embodiment, a launch column becomes the nomenclature when two or more launch pillars are connected together with a centralized chamber formed between them, and cladded together with a light material. The central chamber will house the arresting cables which form part of the brake system of the invention. One launch pillar with a chamber attached to it will constitute a launch column. However, for the purpose of evacuating large number of people which is the focus of the invention, it is uneconomical to build 1-carrier system, except of course for a president! The number of pillars determines the size of the system, that is, the number of evacuees that can launch simultaneously. The second preferred embodiment is a cabin embodiment which also runs on vertical guide rails, preferably, a bearing and a round pipe (launch pillar) mesh. The launch pillar/launch column is held in position by anchoring the metal framework to the concrete wall of the shaft. Both embodiments have a stack of ride units above the launch station for the purpose of multiple launches.

Carrier/Ride Unit and Emergency Escape Cabin are the descent embodiments of the invention. The two embodiments engage with the launcher, reversibly though, and thus, remain suspended by it, in the shaft at Idle Mode. Unlike the launcher that descends only a short distance to accomplish a launch and returns to the launch station for another, the descending ride unit after disengagement continues to descend to the ground station with the escapee coupled to its load point, or safely seated inside the cabin. The two descent embodiments have rollers that mesh with the guide rails much like the rail wheel and the track.

Brake Assembly. This comprises arresting rod(s) which is attached to the ride unit and spring loaded twines hung on the launch column or the shaft wall with the cable laid across the path of descending ride unit. The twine impacts the arresting rod(s) to cause a retardation in the velocity of the ride units. Brake lining(s) and drum(s) complement the arresting cables to smoothen out the momentum of deceleration to a near-zero ejection speed.

Ejection System. Because launcher turnaround is short (about two minutes), there is the need to quickly and safely clear the escapees from the system to give way to others following behind in order to avoid pileup. An integral part of the invention is an ejection mechanism that disengages the escapee from the ride unit and safely rolls him out of the shaft.

The mechanism of operation of the present invention depends on the delicate balance between the opposing forces of the launcher spring load and the launcher. When one counterbalances the other as in the present invention, the forces cancel out and the launcher remains stationary on the launch station. Nevertheless, a beam lock secures the launcher firmly to the launch column to prevent a premature initiation of launch as additional weights (of the escapees) are added. During emergency evacuation, the additional weights of evacuees upset the delicate balance between the opposing forces in favor of a downward motion of the launcher. The trigger comes from the launch pedal which through the pedal release pushrod operates the catcher that locks down the pedal. The pedal now pops out of its recess, signifying that the system is LAUNCH-READY. The escapee depresses the pedal back into its recess once again and the beam lock pushrod unlocks the launcher which swings downward in the LAUNCH MODE. Again, the catcher safely holds the pedal down for the next launch. As the launcher descends, the floor lock actuators operate the floor locks and unlock them. With the floor pieces freed, the retractors push them apart against their return springs. When the ride unit safely descends through the maximally-retracted floor pieces, the decoupler runs out of length and pulls away with the beam arm, thus, disengaging the ride unit from the beam. Rid of the disequilibrium that favored the downward motion of the launcher, the odds are reversed and the launcher, now lighter in weight, ascends back to the launch station ready for the next launch. The ride unit conveying the escapee rapidly descends down the shaft and soon is arrested by the Arresting cables and the auxiliary brake system. At ejection station the slanting tarpaulin across the path of the descending surfboard causes the surfboard to undergo rotation and align with it as the ejection blocks bring the downward motion of the surfboard (and escapee) to a momentary stop. Meanwhile, levers attached to the launch column unlock the surfboard from the ride unit at the ejection station. Under its own weight, the ride unit continues to roll down unimpeded to drop off on the ground below while the surfboard aided by plastic rollers affixed to it, rolls down the tarpaulin surface with its hook safely dipped into a slit. When his feet touch the ground the escapee disentangles his surfboard from the tarpaulin before disentangling himself from it. The launch is over. The cabin embodiments works much the same way with arresting cables and sliders as speed check and ultimately reaches the ground station where it is “ejected” from the guide rails.

The foregoing describes the invention and how it works.

### BRIEF DESCRIPTION OF THE DRAWINGS

The present invention would be better understood by the accompanying drawings and descriptions.

FIG. 1A is a view of the approach to the launch room/station.

FIG. 1B is a view of the interior of the launch room of an embodiment of the present invention at idle mode, with a stack of carrier/ride units and solar batteries above the launch room.

FIG. 2A is a front view of the launcher of an embodiment of the present invention on its guide rails, with and without the launch column insitu.

FIG. 2B are the side views of the launcher as it relates to the retractile floor and its retraction cables according to an embodiment of the present invention.

FIG. 2C is an adaptation of the carrier/ride unit for the purpose of conveying load. Trained personnel such as soldiers can hook themselves up on the ride unit without a surfboard.

FIG. 3A is a schematic drawing of a single-carrier system and a multi-carrier system according to an embodiment of the present invention.

FIG. 3B is a perspective view of the embodiment in FIG. 3A in the descending mode.

FIG. 3C shows an arresting cable impacting a descending carrier/ride unit during operation.

FIG. 4 is a scene in a fire evacuation exercise showing evacuees connecting themselves to an embodiment of the invention, while another set readies and waits. An empty surfboard is shown with a launch seat, harness, hand rails and foot rests.

FIG. 5A is an exploded view of the launch pillar and a cross-sectional view of the carrier block-launch pillar assembly.

FIG. 5B is a longitudinal cross sectional view of the carrier block within the launch pillar.

FIG. 6A shows a side view of a carrier/ride unit in the “brake zone”.

FIG. 6B shows the auxiliary brake of the carrier/ride unit and its cooler during operation in the “brake zone”.

FIG. 6C shows an anterior cross sectional view of the carrier/ride unit with the load point superimposed.

FIG. 6D is a cross sectional view of the launch pillar-carrier block assembly with the bearings meshed with the guide rails.

FIG. 7A is a cross sectional view of the carrier/ride unit at the level of the arresting rod.

FIG. 7B shows the front and the side views of an ejection-capable load—conveying embodiment of the carrier/ride unit.

FIG. 8A shows the side and the back views of the surfboard.

FIG. 8B is a schematic view of the launcher-release mechanism of the first preferred embodiment, with a portion enlarged.

FIG. 8C shows the invention in Ejection Mode with portions enlarged.

FIG. 9 shows the first preferred embodiment engaged with the launcher in Idle Mode with a portion enlarged.

FIGS. 10A, 10B, 10C show a 2-carrier system, 4-carrier system and multi-carrier system respectively.

FIG. 11A shows the retractile floor in the OPEN and CLOSE configuration.

FIG. 11B shows the floor-lock mechanism in the LOCKED and UNLOCKED configuration.

FIG. 11C shows the various stages of the launcher during launch.

FIG. 12A shows the brake assembly in action as the arresting rod impacts the arresting cable. In FIG. 12B the arresting rod drags the cable into the slider. In FIG. 12C the slider works the cable off the arresting rod while the auxiliary brake kicks in.

FIG. 13 shows the close relationship between the “brake zone” and the ejection station.

FIG. 14 shows the chambering contraption that feeds fresh carrier/ride units into the emergency escape device from the carrier “magazine”.

FIG. 15A is a cross sectional view and side view of the emergency escape cabin of the second preferred embodiment.

FIG. 15B shows an emergency escape cabin during floor-level stopover made possible by the Cabin Hanger Control Unit (CHCU) shown on the right.

FIG. 16 is a prelaunch view from above showing an emergency escape cabin with the cabin door open.

FIG. 17A shows the side views of the emergency escape cabin launcher.

FIG. 17B shows the launcher engaged with the cabin.

FIG. 18 is a view of the launcher of the first preferred embodiment from above the launch room.

FIG. 19 is a perspective view of the first and the second preferred embodiments of the present invention in the descending mode, with arresting cable/slider brake units as speed check.

FIG. 20A is a view of the cabin stack with the cabin stack decoupler enlarged.

FIG. 20B is a schematic diagram of a Self-actuation cabin/carrier-release mechanism with a portion enlarged.

FIG. 21A shows an adaptation to work the cabin hanger control unit from the emergency escape cabin.

FIG. 21B shows an adaptation to initiate launch from the cabin.

FIG. 22 is a schematic representation of a floor-level (stopover) hanger.

FIG. 23 is a view of the ground station of the second preferred embodiment of the present invention.

FIG. 24 is cabin-actuated floor-level or stopover auxiliary brake system of the cabin embodiment.

### DETAILED DESCRIPTION OF THE PREFERRED EMBODIMENT

The present invention will be made clearer by a detailed description and drawings of the embodiments. In the recitation that follows, it is to be understood that like reference characters designate like or corresponding parts, and sometimes—for reasons of convenience—like functions, where such usage in my considered opinion will not cause confusion. For examples, in the drawings, the number 64 is used to refer to fulcrum in a general sense, but not in all cases where there is a fulcrum. Variously, numbers 133, 22 etc. are similarly used. This must not limit the invention.

For skyscraper occupants, when the alarm sounds for emergency evacuation of the building, usually as a result of fire outbreak, bomb scare etc. all are urged to gather at the fire evacuation point for orderly evacuation from the building. Usually, lifts are shut down during a building fire and the stairways and conventional fire escapes inundate with people fleeing the building.

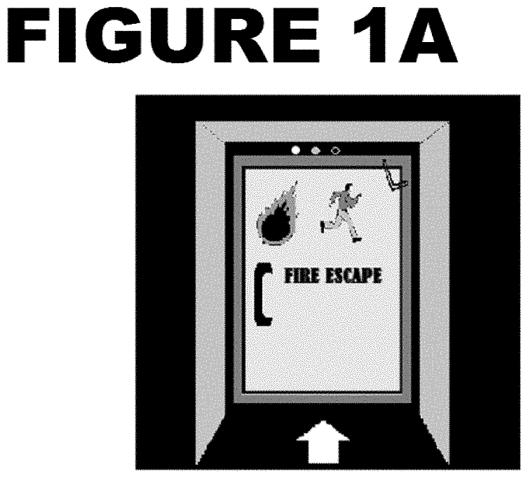

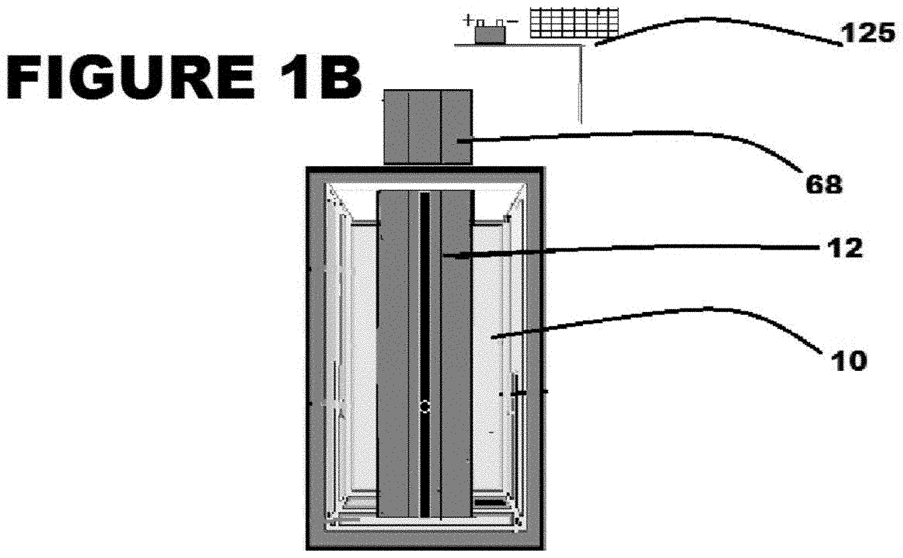

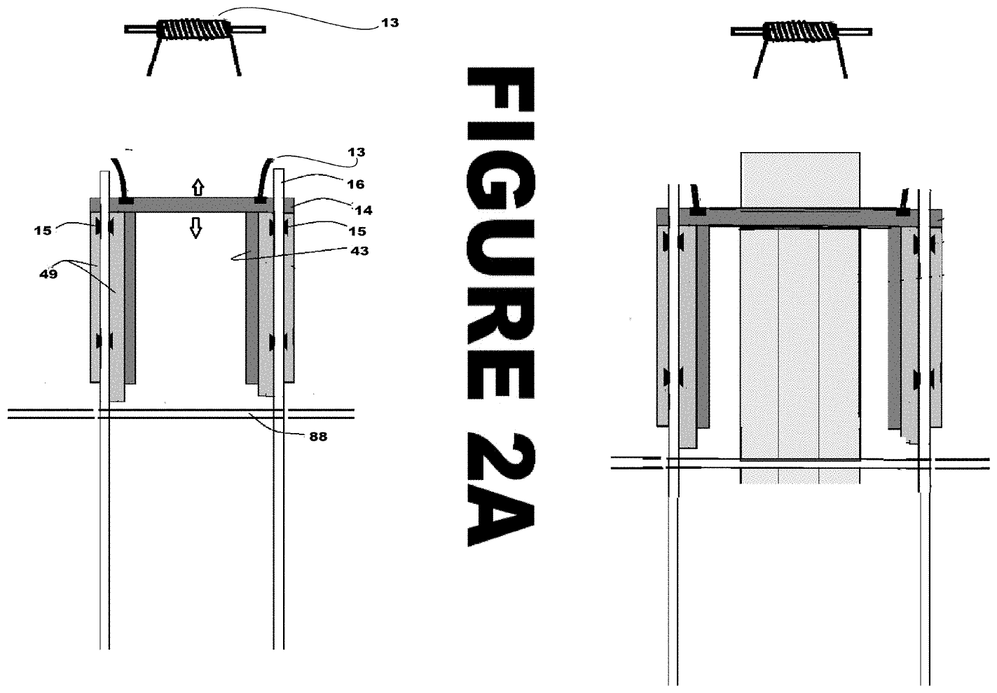

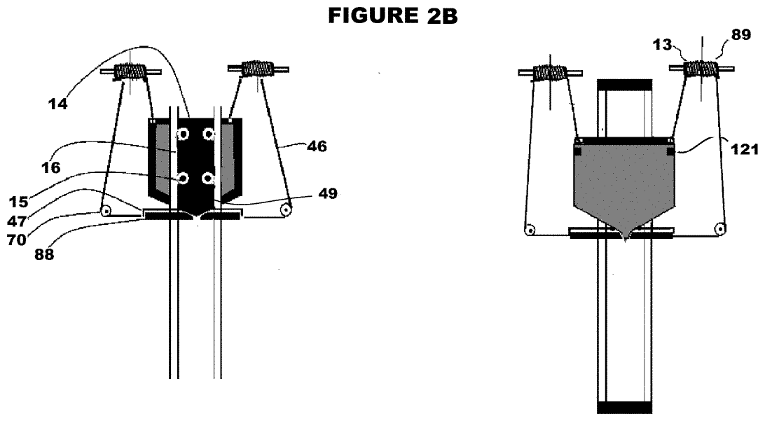

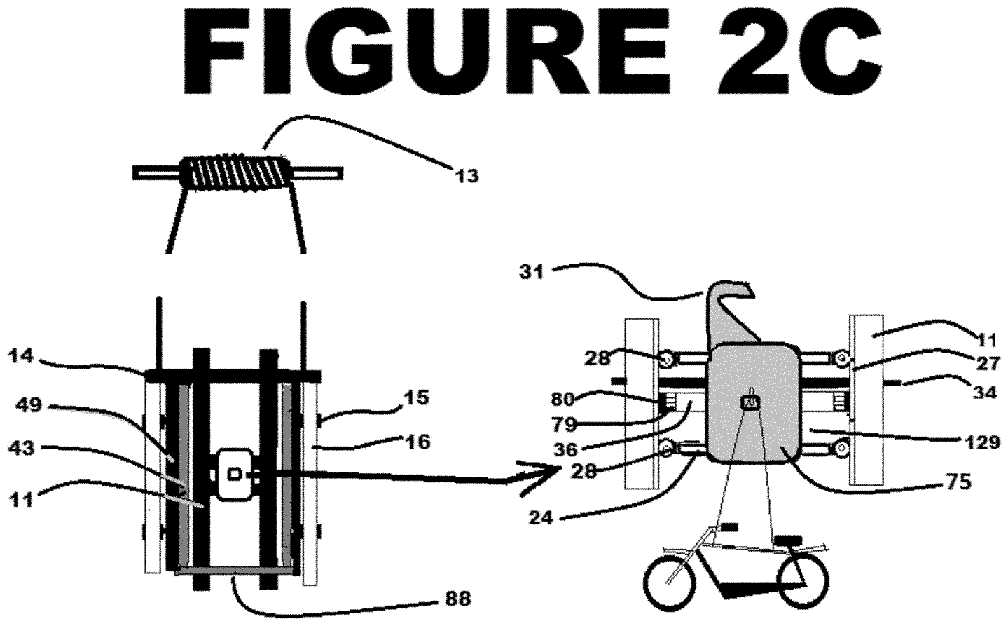

The present invention situated at the fire evacuation area in the building, has markers or signs on the floor or hung on the ceiling, pointing in the right direction. The door of the launch room is shown in FIG. 1A with FIRE ESCAPE or fire sign conspicuously across it in different languages. In the first preferred embodiment of the present invention, the launcher referenced FIGS. 2A, 2B, 2C is installed inside this launch room 10 which is shown in FIG. 1B and situated at the apex of a shaft 122 running down to the ground. In buildings constructed with the invention as emergency escape device, the shaft 122 can be located inside the building, perhaps side by side with the lifts. Buildings already standing can have the device installed inside an improvised shafts constructed in the front, at the sides or behind the buildings. With the hindsight of recent events of terrorist attack on skyscrapers with bombs and airplanes, it is recommended that the invention be installed at different corners of a building such that structural damage to one area of the building does not necessarily hinder evacuation of persons from the undamaged areas of the building. Preferably, this emergency evacuation device referenced FIG. 1 to FIG. 24 is installed on each floor. However, to ease space constraints, two or more floors can share the same fire evacuation point or points. In the first preferred embodiment of this invention, each shaft 122 is dedicated to a fire point meaning that when launched, an escapee's descent to the ground is uninterrupted.

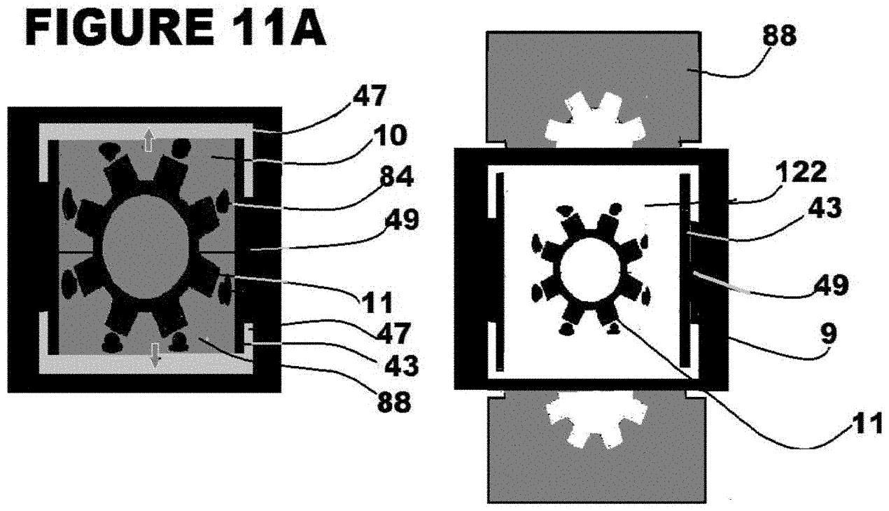

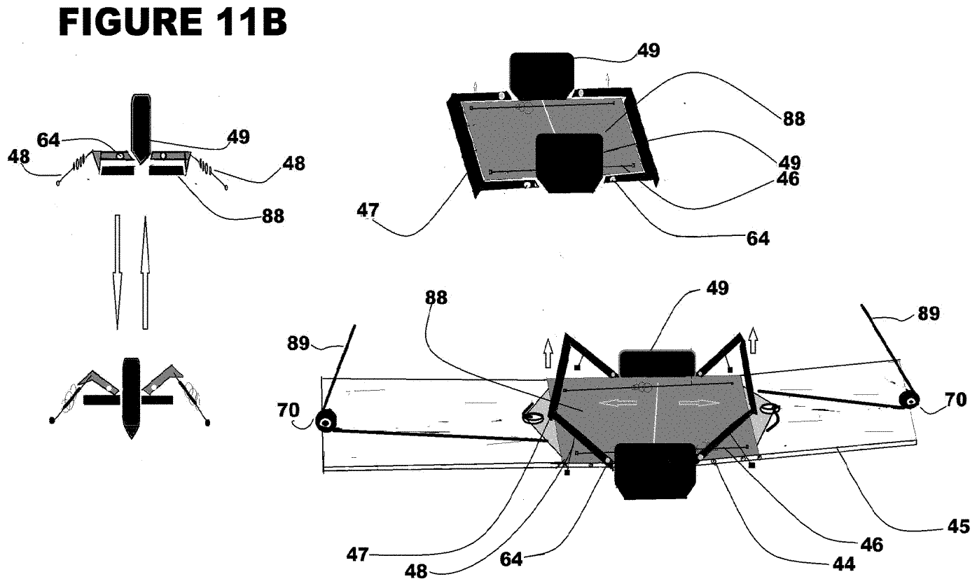

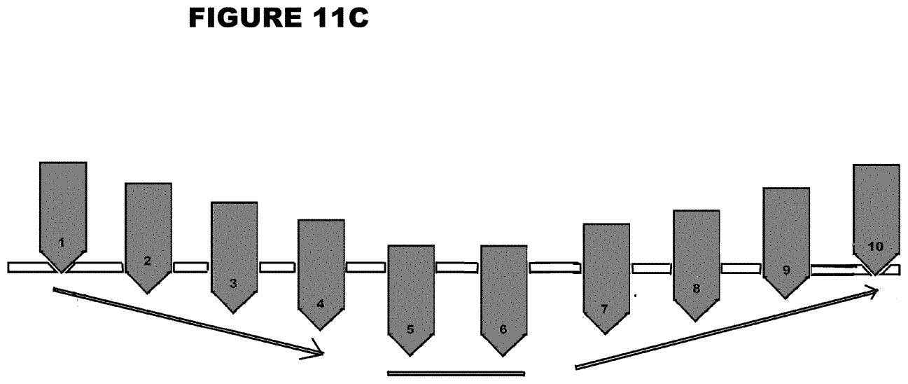

Overhead in the launch room 10 hang spring loaded cables 13 firmly secured to the concrete shaft or metal structure of an improvised shaft 9. The spring loaded cable reels 13 can be positioned at a lower level with the cables running to an overhead pulley before being attached to the beam 14. It is noteworthy that the beam 14 is suspended solely by the said spring loaded cables 13 as shown in FIG. 2A. The beam 14 has appendages. On its two opposing sides, floor retractors 43 are rigidly joined to it. The floor retractor 43 is rectangular or square-shaped with a tapering lower aspect which has a wide angle of divergence as shown in FIG. 2B. The floor retractor 43 is about the height and length of the launch room 10 wherein it is installed for reasons that shall become clearer as I discuss the invention further. The structure can be formed by bending a steel pipe to that shape, with crossbars to give it strength. The floor retractor 43 as the name implies, working in pair, is meant to retract a two-piece retractile floor 88 mounted on rollers 44 and installed in the launch room 10 as shown in FIGS. 2B and 11B. On its outer (shaft) surface, another structure called floor-lock actuator 49 shown in FIG. 2A, is rigidly joined to the floor retractor 43. The two can be forged together in one piece. The floor lock actuator 49 resembles the retractor 43 in shape, only it is narrower in the horizontal axis. It is designed to operate the lock system of the retractile floor which prevents the retractile floor 88 from pulling apart until launch is approved. Its lower tapering end is a shade longer than the floor retractor's 43; the reason being that during descent it must engage with the floor lock angle iron 47 shown in FIG. 11B and unlock the retractile floor 88 as a prelude to the retractor 43 engaging with and rolling apart the floor pieces 88 as shown in FIG. 11A.

Being firmly attached together as discussed and when connected to a roller-guide rail system, the beam 14, floor retractors 43 and floor lock actuators 49, will swing up and down in one piece and constitute what I call the Launcher depicted in FIG. 2A, FIG. 2B, FIG. 2C. The roller-guide rail system shown in FIG. 2A, FIG. 2B, FIG. 2C is to stabilize the launcher without which the structure will be unstable. Also it enables the launcher to rise and fall during launch to accomplish the task of operating the retractile floor pieces 88. The roller bearings 15 are affixed to the shaft surface of the floor retractor 43 and made to run on its guide rail 16 anchored to the concrete shaft 9. The guide rails 16 run down for a short distance below the launch room 10 to enable the launcher to maximally retract the retractile floor 88 and accomplish a launch. FIG. 11C shows the launcher in the Launch Mode in relation to the retractile floor 88.

The retractile floor 88 is shown clearly in FIG. 11A as a two-piece one, designed to retract backward from each other and they retract fully in order to enable unrestrained communication between the launch room/station 10 and the shaft 122. To be able to retract as said, rollers 44 are affixed underneath the floor 88 and the rollers 44 run on a guide rail system installed in the shaft 122 and depicted in FIG. 11B. The floor 88 is made of a light but strong, rust-free material such as an alloy of aluminum. The two halves of the floor 88 are held together preferably by spring loaded cables 89, which may be hung together with the launcher spring loaded cables 13 and made to spin in the same axis as shown in FIG. 2B; that is, they will unwind as well as recoil together in the same direction. FIG. 11B shows the connection as the two halves are drawn together to a close after launch by the spring loaded cables 89, each working via the cable pulley opposite to the floor piece. A return spring 46 connected between the two halves and which pulls them together, can be an alternative.

The same FIG. 11B shows the two halves of the retractile floor 88 encased at their far ends by a floor-lock angle iron 47 designed to fit the floor ends with two right-angle bends at the corners. The angle iron 47 has a fulcrum 64 located on the opposite sides of it to enable it rotate in the vertical axis, necessary to lock and unlock the far ends of the retractile floor 88. The fulcrum 64 is not at the free end of the angle iron but rather toward the free end so that a shorter arm is created after the fulcrum 64. Therefore, an impact at the end of the shorter arm of the angle iron 47 will cause a rotation of the opposite end of it against a return spring 48. To cause the angle iron 47 to unlock the floor piece 88, the floor lock actuators 49 will have to impact the ends of the shorter arms of the angle iron 47 to rotate its far-locking ends. It can be deduced therefore that the longitudinal dimension of the floor-lock actuator 49 must be such as to exceed the distance between the two shorter arms of the angle iron 47 by a small margin in order to work the ends and roll up the floor lock 47 at an acute angle. The tapering end of the floor-lock actuator 49 serves the purpose of engagement as well as creating the necessary variation in the amplitude of the rotation for smooth operation. The two halves of the retractile floor 88 have similar but separate lock mechanisms; nevertheless, they operate together as a unit as depicted in FIG. 11B with the actuators 49 working between the two lock units and interacting with them at the same time. In summary therefore when it comes to the workings of the retractile floor 88, the floor return springs 89 works to keep the two floor halves together, while the descending launcher retracts them against the resistance of the said spring load 89. Therefore, it becomes easier to understand that the resistance of the floor return springs 89 must be taken into account when determining the totality of the downward force necessary to initiate and complete a launch satisfactorily.

The launch room floor 88 is indented by the midline structures in the launch room as shown in FIG. 11A. At the extreme left and right of the midline, there are apertures which constitute the interaction points between the retractile floor 88 on the one hand and the floor retractors 43 and the floor lock actuators 49 on the other. The apertures are made to allow the two structures that work the retractile floor 88 dip in-between the two floor pieces at the appropriate moment in order to cause the said interaction. Because such interaction is bound to be recurrent, I recommend that the interacting edges be rimmed preferably with nonabrasive material and greased to allow smooth movement between them with minimal friction.

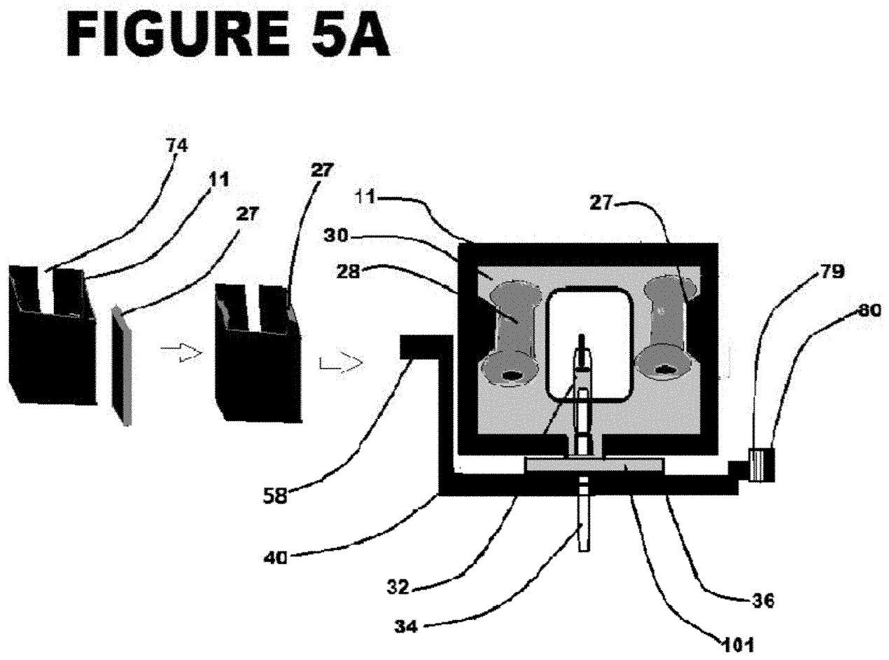

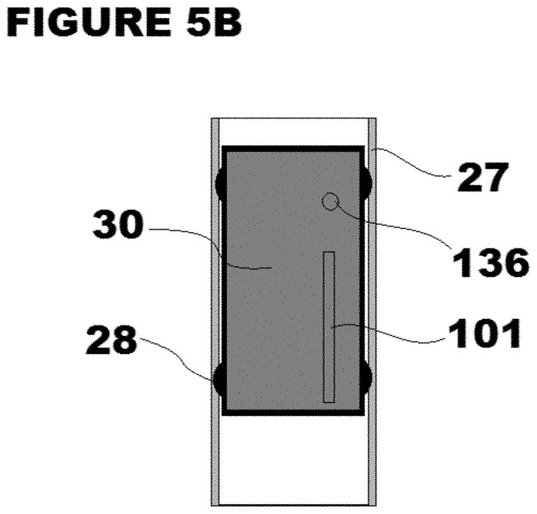

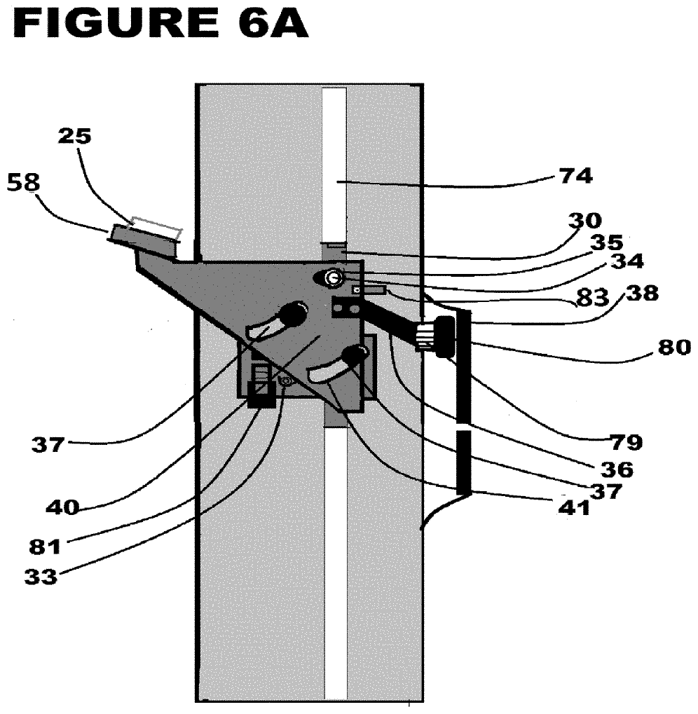

By far, the biggest indentation is that of the launch column 12. FIG. 11A shows the launch column 12 in relation to the launch room 10 and the retractile floor 88. The launch column 12 cuts through the center of the launch room 10 from the ejection station below, and rises through and above the launch beam 14 to the stack 68. In its simplest form, which is a 1(person)-carrier system, the launch pillar 11 is the appropriate name, and it will serve the interest of a better understanding of the two names as the discussion continues. The launch pillar 11 is a square, round or rectangular pipe of about 5 mm thickness shown in FIG. 5A. It is laid down the shaft 122, from the launch room/station 10 above to the ejection station 100 below. The launch pillar 11 is about 15 cm×20 cm with its longer axis aligned to the front (outward) direction. A groove 74, about 5 cm wide, runs lengthwise of it by the side in the middle. The groove 74 enables a connection to be made between the block 30 of the carrier/ride unit 23 running inside the launch pillar 11 and its accessories running on the outside.

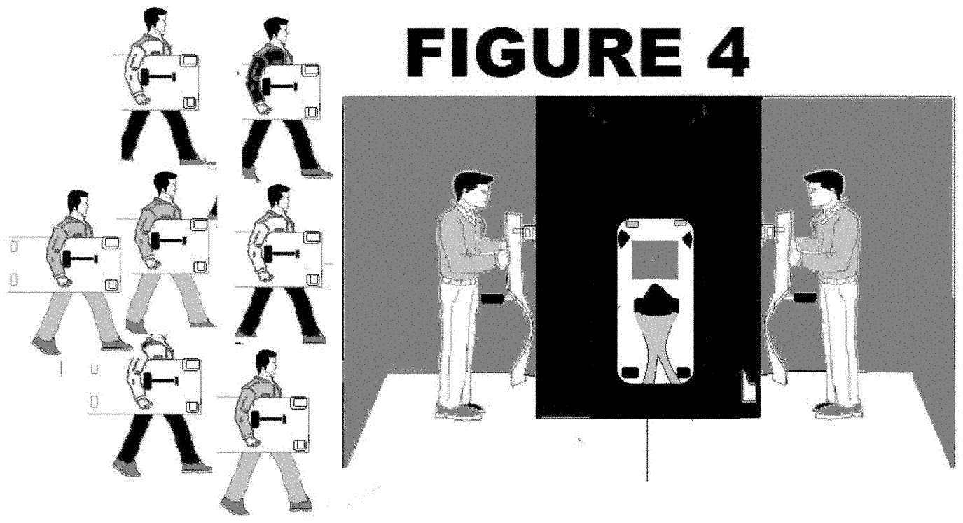

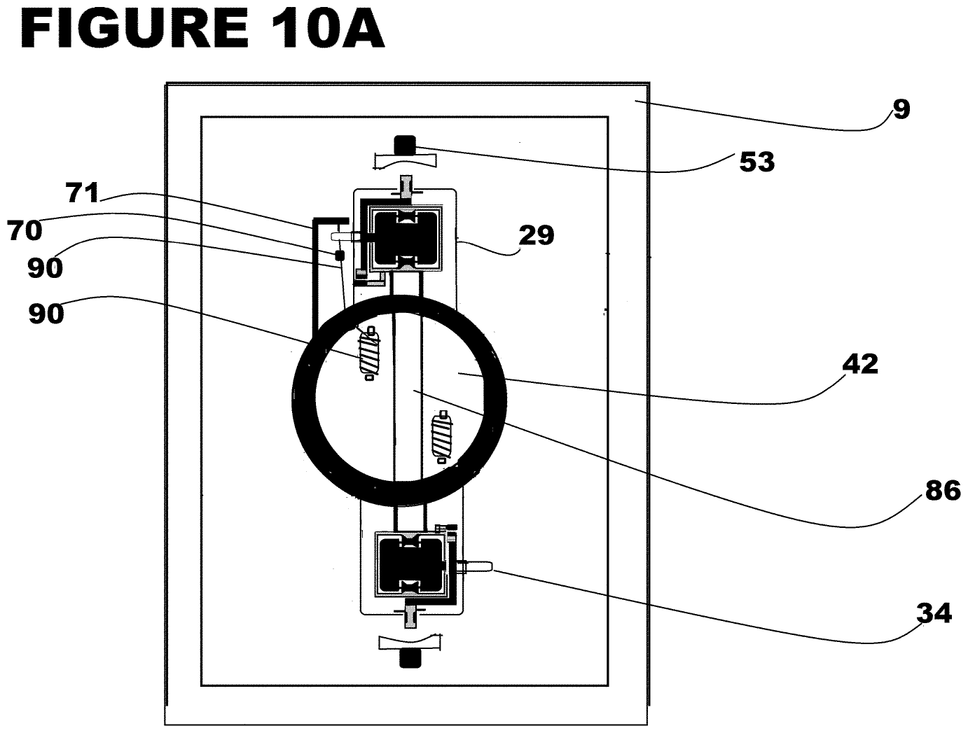

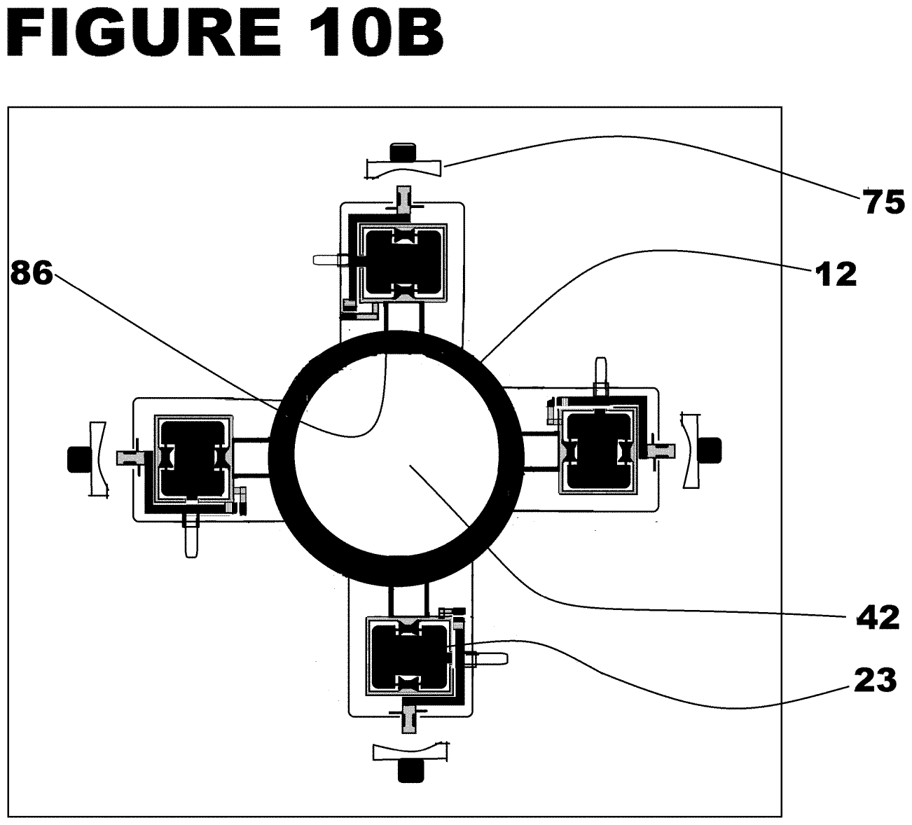

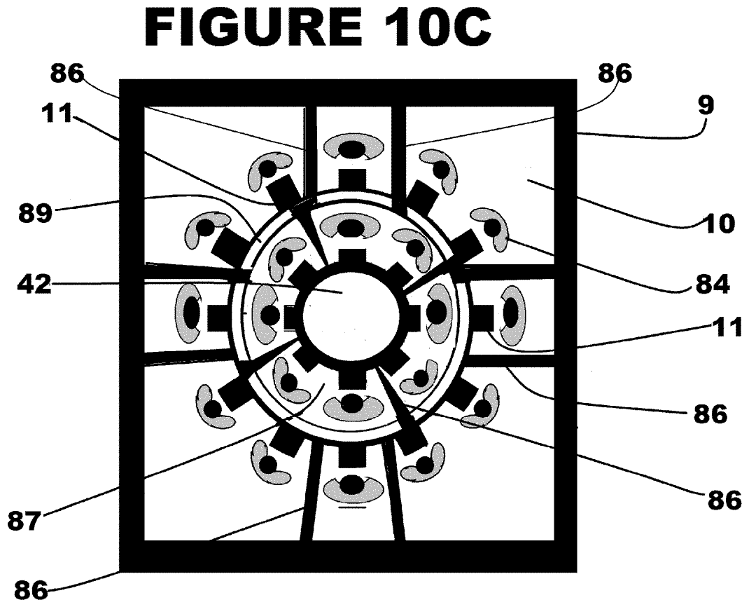

Because the launch pillar 11 is laid down the entire length of the shaft 122 almost, it is tooled and made to fit end-to-end without compromising the alignment of the guide rails 27 or groove 74. In a 2-carrier system shown in FIG. 10A, the launch pillars 11 are positioned to face the opposite directions with an intervening space between them. A central chamber 42 is formed out of this space which may take the shape of a circle, square, rectangle or a hexagon. This new structure, the cladding 29 which encases the two launch pillars 11 and the central chamber 42 is called a launch column 12. With the claddings 29 as described and shown in FIG. 1B and FIG. 4, accessories of the invention disappear into the launch column 12, save for the load points 58 (with their slits down the cladding) that the escapee connects his surfboard to, and perhaps, the launch pedal in the case of the small-number carrier system such as a 2-carrier system. Of course the launch column can be dispensed with, leaving the launch pillars 11, the interconnecting metallic framework which rigidly hold the structure together and the arresting cables 90 (which will be discussed hereinafter) visible. However, in the first preferred embodiment of this invention, I recommend that the chamber 42 and the cladding 29 be incorporated because of the decency they engender. In a multi-carrier system shown in FIG. 10C, the pillars 11 assume a circular arrangement around the chamber like a giant gearwheel. Indeed, in very large systems, one “gearwheel” can conveniently be worked into another to maximize the economy of space as the circumference of the system becomes very large. In such system, the outermost “gearwheel” with the largest circumference will accommodate another launch compartment of a smaller circumference, and perhaps another yet. The anchorage of the system will be such that the “gearwheel” within, derives its anchorage from the “gearwheel” without as shown in FIG. 10C. The outermost “gearwheel” is anchored to the concrete/metal shaft 9. All compartments are controlled by one launcher.

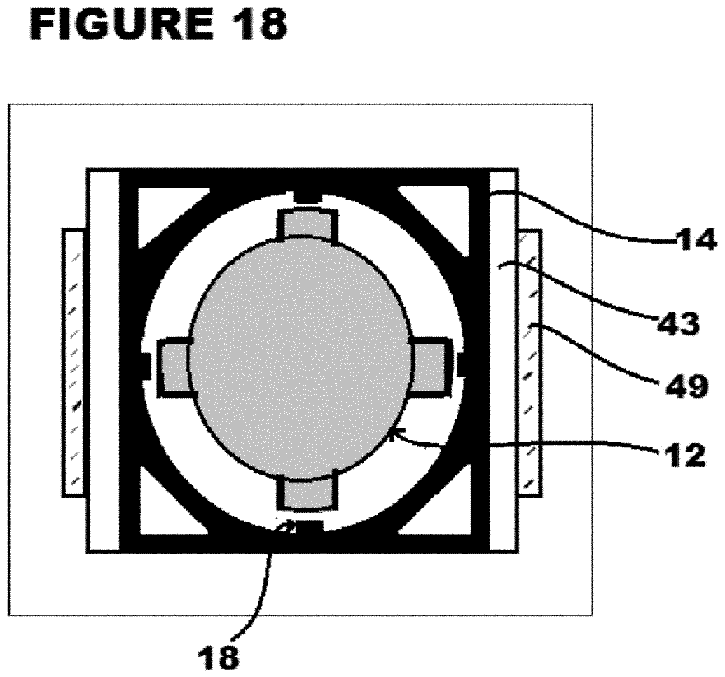

As said earlier, the shape of the launch column 12 varies according to the size of the system and the beam 14 with it. Because the beam 14 is wider in its cross sectional diameter than the launch column 12, the beam 14 is forged with a central metallic opening shown in FIG. 18 which will approximate the circumference of the launch column 12 and thus, provide an aligned coupling, through the beam coupling arm 18, with the carriers/ride unit 23 during the period of its engagement with the launcher.

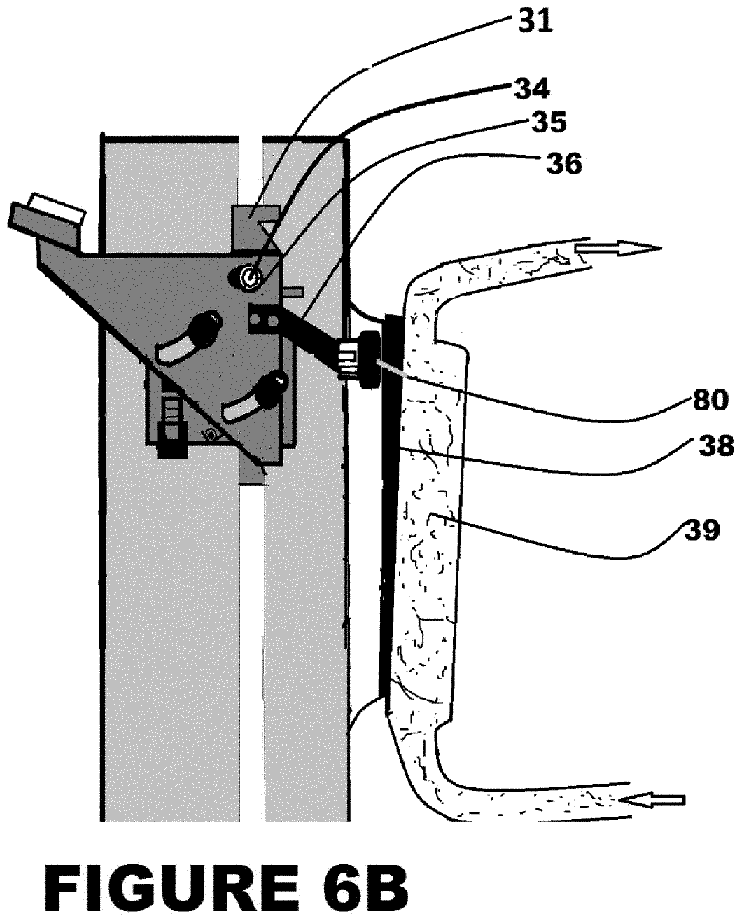

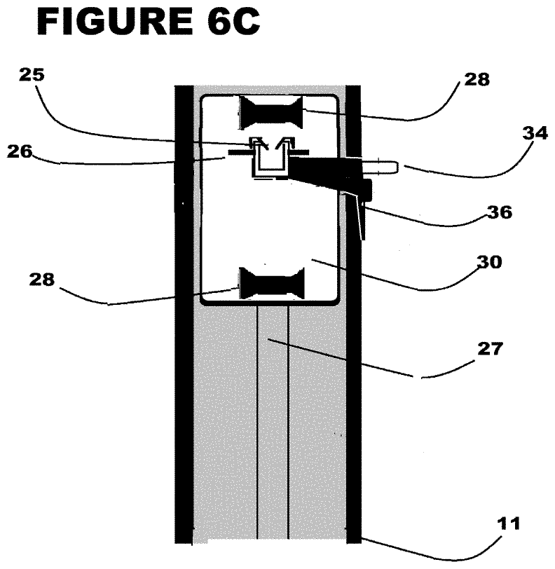

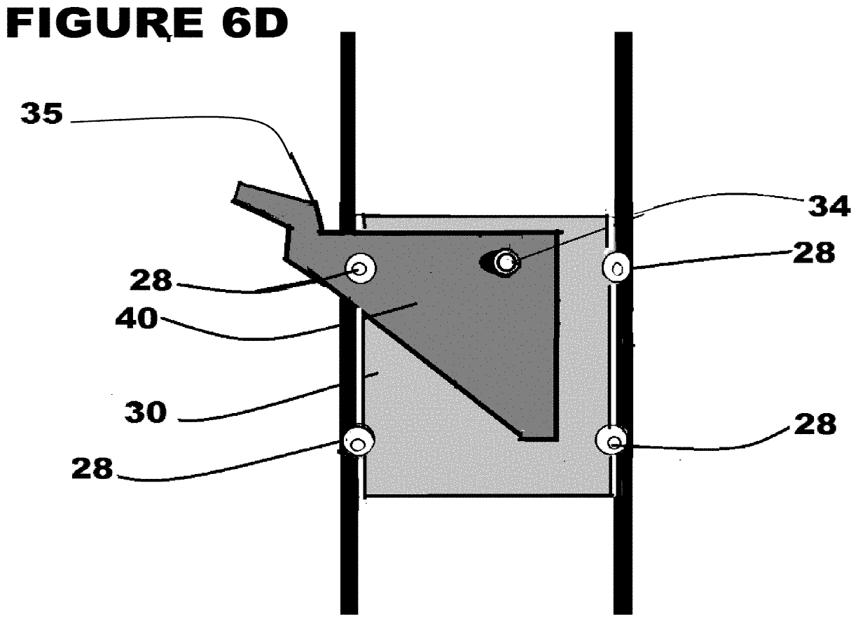

At this stage, I will describe the carrier/ride unit in detail. The carrier/ride unit referenced FIG. 6A, 6B, 6C, 6D, 7A, 7B is gravity based ride unit that runs on guide rails 27. In the first preferred embodiment of the present invention, the guide rails 27 are laid inside the launch pillar 11. One or two guide rails 27 can be laid on the opposing sides of the launch pillar 11, that is, anteriorly and posteriorly, with the launch pillar groove 74 on either of the two remaining sides. The carrier/ride unit 23 has a central square or rectangular metallic block 30 of a strong rust-free material such as stainless steel or an alloy that combines lightness with high tensile strength. Because it is meant to run inside the launch pillar 11, it is about 8 mm less in its cross-sectional diameter and about 30 cm long. When inserted into the launch pillar 11, the block fits snugly into the pipe as shown in FIG. 5A and FIG. 5B. The carrier block 30, preferably, is forged to the shape that is required of it and it incorporates an extension called the cross plate 101 that extends across the launch pillar groove 74 to the outside. It is noteworthy that the cross plate 101 is only joined to the lower half of the 30 cm long carrier block; that means, the cross plate 101 has a length span of about 15 cm. The upper end of the carrier block 30 has its own extension across the said groove 74 in the form of a round pipe-like protuberance 136 which like the cross plate 101 is forged together with the carrier block 30. Both the cross plate 101 and the round pipe 136 provide anchorage for accessories of the carrier/ride unit 23 that run on the outside of the launch pillar 11. The cross plate 101 is T-shaped with a very short leg (a few millimeters) across the launch pillar groove 74 before the plate runs anterior-posterior with attachment points for the load plate 40. The cross plate 101 is aligned to the launch pillar groove 74 and does not impact it during operation. The load plate 40 is also a thick plate and of such material as can carry the human load repeatedly without fatigue.

To enable the carrier block 30 run smoothly on its guide rail 27 as depicted in FIG. 5B, the carrier block 30 has rollers 28 incorporated to it. Because of the limited clearance between the carrier block 30 and the launch pillar 11, and because it is desired that the clearance be maintained, the carrier block 30 has its mid-section grooved in the vertical axis, at the front and at the back to accommodate a roller bearing 28 of about 10 cm long, along the cone. This is the case for a design with two bearings at the upper poles of the block and two others at the lower poles. The carrier block 30 can be made to run on four smaller roller bearings 28 at each end instead, with the intervening 2 mm clearance between the carrier block 30, and the launch pillar 11 preserved when the two are coupled together. FIG. 5A is an exploded view of the launch pillar 11 and roller guide rail 27 as well as a view of the assemblage of the launch pillar 11 and the carrier block 30. The mesh between the roller bearings 28 and the guide rails 27 shown in FIGS. 5A, 5B and 6C is a good one. Thus, the relationship between the two within the launch pillar 11 assuredly is a safe one devoid of derailment.

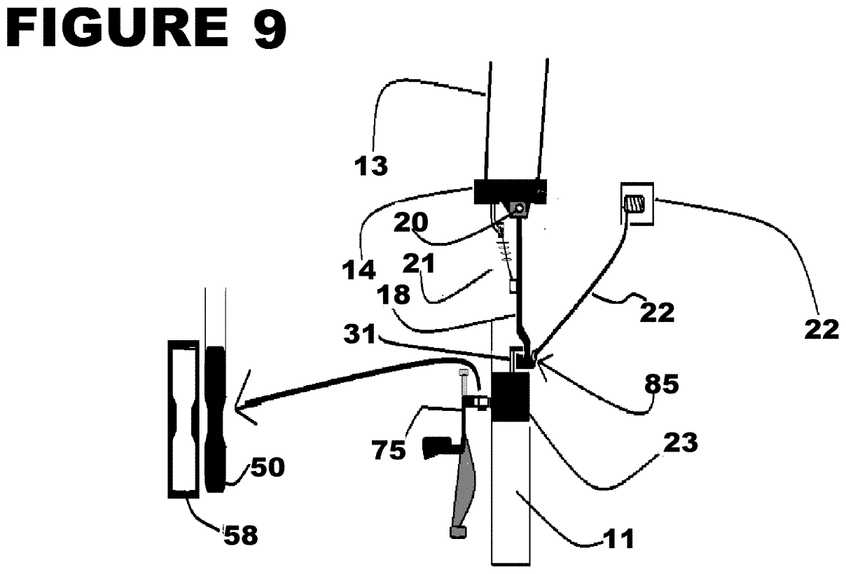

As hereinbefore mentioned, the load plate 40 derives its anchorage from the carrier block 30 which provides it with a fulcrum 35 on its round pipe appendage 136. The fulcrum 35 enables a rotational movement of the load plate 40 in the vertical axis. Two curved grooves 41 on the load plate 40 each with a rivet 37 within provide needed stability of the load plate 40 while performing the rotational movement. The load plate 40 is cut to similar shape as a right-angled triangle with the hypotenuse facing downward and the apex pointing frontally, that is, forward as shown in FIG. 6A and FIG. 6B. Toward the apex, it bends to connect with a channel at the center point of the launch pillar 11 as shown in FIG. 5. The channel is rigidly connected to the load plate 40 and represents the load point receptacle 58 of the carrier/ride unit 23. Its orientation is anterior-posterior and it is about 15 cm long by 5 cm wide. The channel is the female and it has kinks on its interior surfaces which keys with and stabilizes the male rectangular rod—the surfboard coupling head 50. The surfboard coupling head 50 is indented to make it fit into the load point receptacle 58 without wobbling as shown in the expanded portion in FIG. 9. However, it is recommended that the two key surfaces slant away from each other to avoid jamming during disengagement. To make the said disengagement near impossible until desired, when coupled together, the surfboard head 50 and the load point 58 are locked together by a catcher-like mechanism 25 incorporated to the load point 58. The catcher has two appendages 26 jutting out on either side of the load point 58 like butterfly wings and either can unlock the surfboard coupling head 50 at ejection station 100 during launch. Protuberances (not shown) on the launch pillar 11 will impact the catcher appendages 26, to unlock the surfboard coupling head 50 which then pulls away from its load point 58 mesh.

The load plate 40 does rotate in the vertical axis on its fulcrum 35, and the load point 58 with it. At Idle Mode, the load point 58 is inclined upward frontally at a sharp or small angle as depicted in FIG. 6B. This is as a result of a spring-stopper system 81 mounted on the cross plate 101 below the load plate 40. The spring 81 is a strong one designed to work with weights upward of thirty kilograms (a hypothetical minimum body mass allowed to use the ride unit) are placed on it. The stopper 81 also assures that the load plate 40 does not rotate beyond a lower (horizontal) limit when load is placed at the load point 58. The stopper 81 is rubber-topped preferably and has a central opening whence the spring 81 emerges. The spring 81 varies the angle of rotation at the fulcrum 35 according to the weight applied on the load point 58. It is important here to emphasize that weight-dependent rotation of the load plate 40 is critical to (a) individualizing the brake power of the invention (b) unlocking the launch pedal 60 at the safe moment—when the escapee is seated.

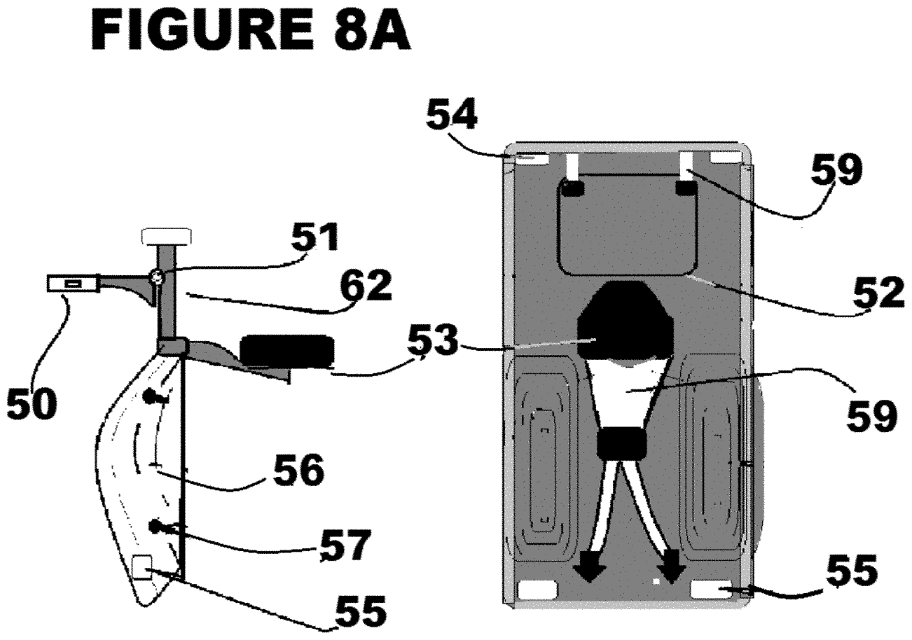

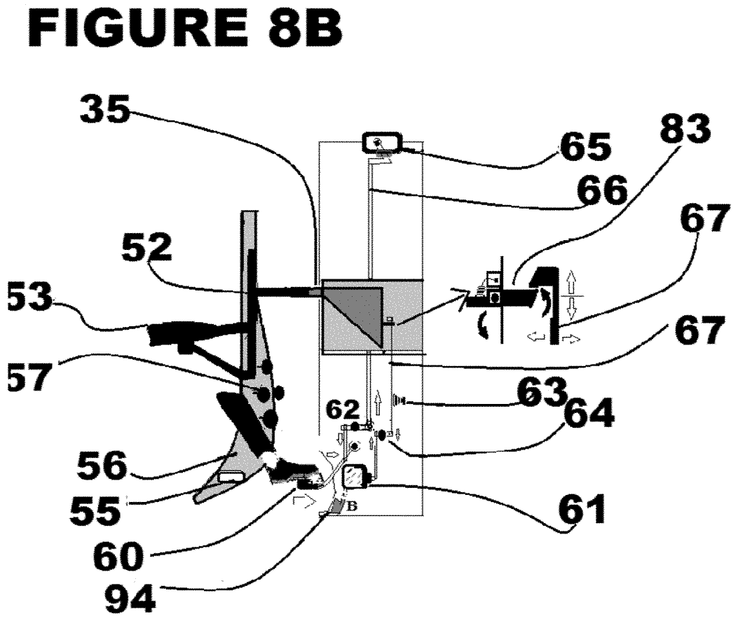

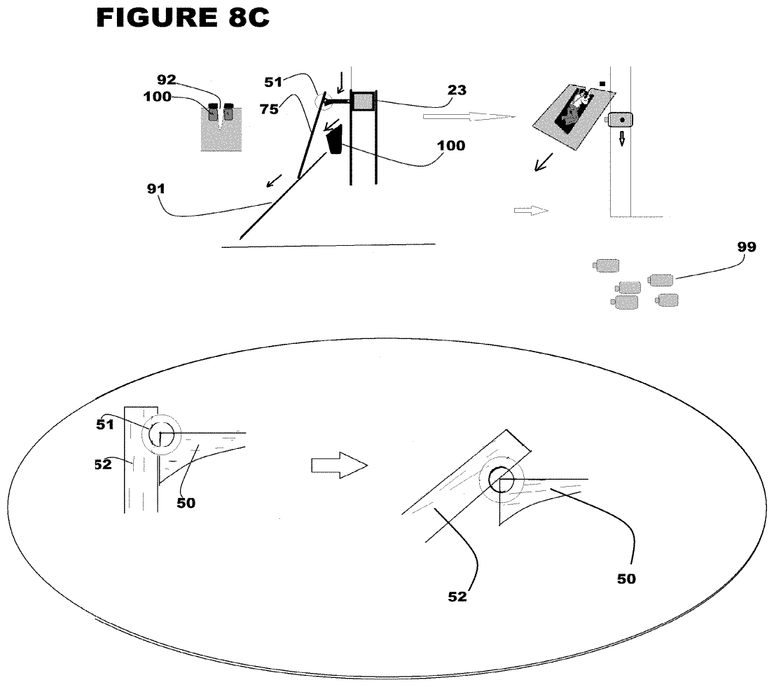

Taking advantage of the weight-induced rotation of the load plate 40, a catcher-release actuator 83 is mounted on the launch column 12 in the launch room 10. The actuator 83 comprises a horizontal lever with a fulcrum at about its midpoint. The purpose of the lever is to cause an upward rotation to take place at its far end when the downward-bound carrier/ride unit 23 impacts the other end of it. In the expanded portion in FIG. 8B, the far end of the lever lies below and in close contact with the mesh point of the catcher release push rod 67 which operates the launch pedal catcher 61. The lever has a stopper on the load plate 40 above it which together with a return spring anchored to the stopper and which works the lever, stabilizes the lever when at rest. At rest, with the carrier/ride unit 23 engaged with the beam arm 18 in the launch room 10, the pedal release actuator 83 and the pedal catcher release push rod 67 are meshed. However, a downward rotation of the load point 58 when force is applied thereon usually, by the weight of the escapee, causes the upward rotation of the far end of the lever which then engages and subsequently raises the catcher release push rod 67 in the process. The movement unlocks the launch pedal 60 and the pedal 60 pops out of its recess in the launch column 12, signifying the Launch-ready Mode.

The launch pedal catcher 61 is positioned behind the long arm of the pedal 60, below its fulcrum. When the pedal 60 is depressed to initiate launch, the catcher 61 locks the pedal arm down and the pedal 60 becomes immobile in the new position 94. The launch pedal 60 is mounted on the launch column 12 within reach of the evacuee. Below the pedal 60, the recess mentioned above is created on the launch column 12 such that when depressed 94 the pedal 60 recedes into the recess where it is held down by the catcher 61 and becomes inaccessible to manipulation by the operator. The pedal lock is a necessary precaution against initiation of launch when evacuees are not ready.

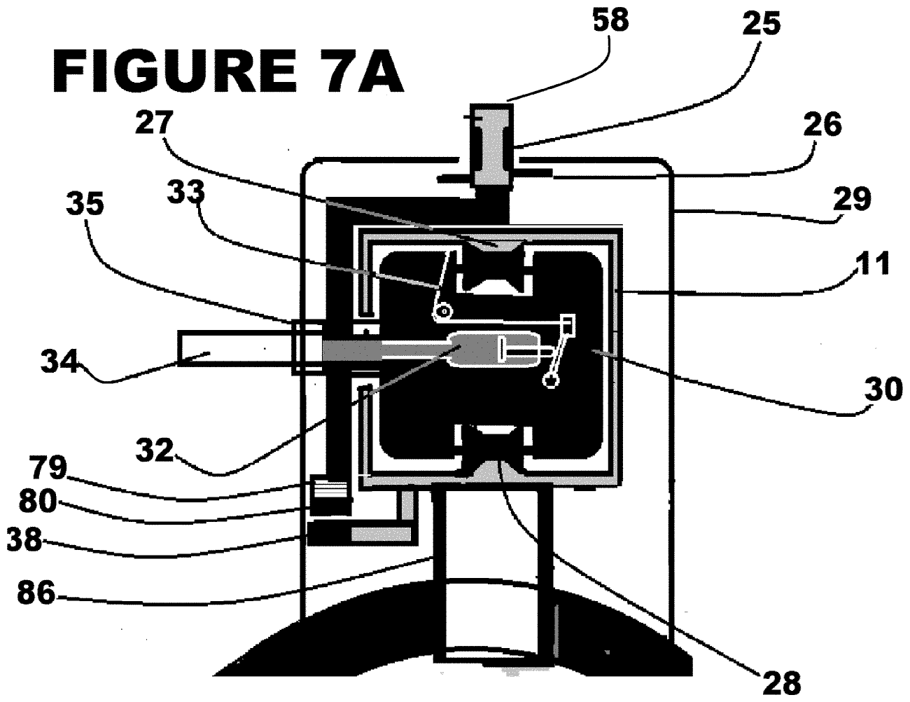

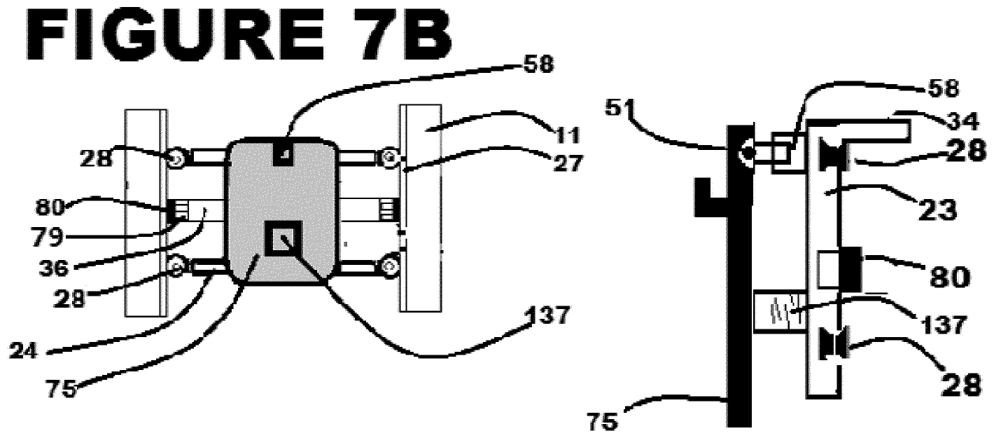

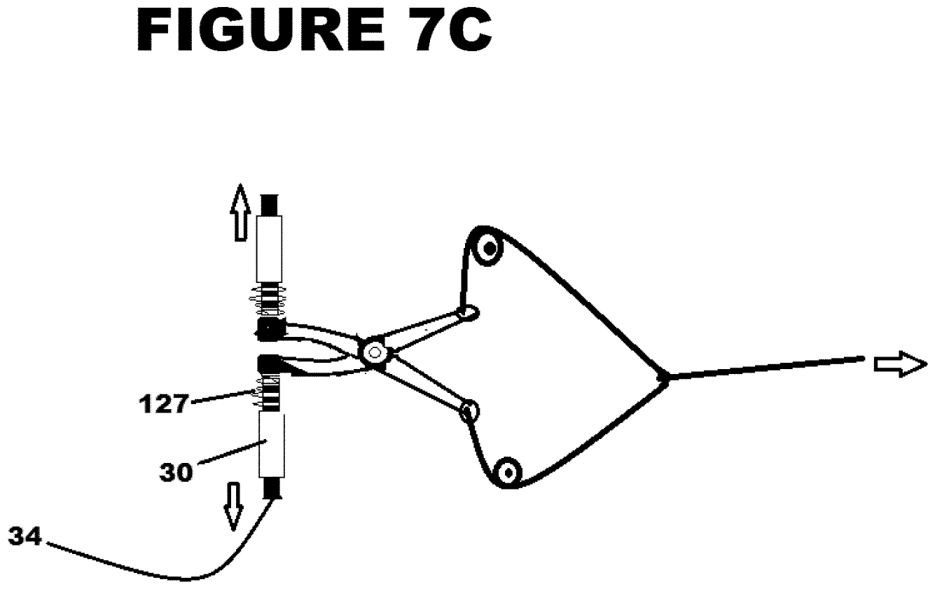

The rotation of the load plate 40 is also exploited to individualize the brake power of the invention as people of various body masses will use the emergency evacuation device. A twine 33 affixed to the load plate 40 is routed through a small pulley on the load plate 40 and ultimately attached to a lever that works a hydraulic piston shown in FIG. 7A. The piston alters the length of a retractile arresting rod 34 which constitutes part of the brake system. The arresting rod 34 is designed to extend or retract within the carrier block 30 appendage 136 like a radio antenna. The load plate fulcrum 35 is built around this pipe-like appendage 136 and provides the desirable rotation needed of the load plate 40. The appendage 136 connects to a larger chamber 32 in the center of the carrier block 30 shown in FIG. 7A. The chamber contains hydraulic fluid and the piston. By its forward movement, the piston transmits the pressure from the load plate 40 across the hydraulic fluid to the arresting rod 34, causing an elongation of the rod in a manner similar to an auto jack. The arresting rod 34 is manually reset after launch because it is undesirable that it retracts during operation. Thus, the piston acts like the gear selector, which determines the length of the arresting rod 34 and indirectly the brake power according to the preferred embodiment of this invention as shall be discussed further. It is possible to adjust the length of the arresting rod 34 by a non-hydraulic concept such as a lever and return-spring arrangement similar to a bicycle brake system as shown in FIG. 7C. However, the possibility of the rod 34 retracting during operation may be an issue.

At Idle Mode as shown in FIG. 9, the carrier/ride unit 23 is engaged with the beam arm 18. The beam arm 18 is a long metallic appendage with a fulcrum 20 on the launch beam 14. Its lower end is designed to engage with the carrier coupling arm 31 in order to provide anchorage for the carrier/ride unit 23 until disengagement takes place during launch. The carrier coupling arm 31 is affixed on the cross plate 101 and shown in FIG. 6B and FIG. 9. The launch beam 14 being wider than the circumference of the launch column 12, has a circular inner ring that approximates the cross sectional diameter of the launch column where the beam arms 18 is connected. FIG. 18 is an aerial view of the launcher showing the circular ring with beam arms 18 connected to it. This makes for aligned coupling with the carrier/ride units and gives the appearance of a giant chandelier with the “beam arm bulbs” hanging straight down from it. A beam arm spring 21 is incorporated to the beam arm 18 to ensure adequate engagement between it and the carrier coupling arm 31 until disengagement takes place. A coil of rope—decoupler 22—affixed to the concrete wall 9 of the shaft and tied to the beam arm 18 works against the beam spring 21 when stretched beyond its length by the downward movement of the launcher. The rope is only as long as the distance deemed necessary for safe disengagement of the carrier/ride unit 23 from the launcher to take place. It must be said as a matter of great import that where more than one decoupler is involved e.g. a 2-carrier system, the ropes must be of equivalent length for all carrier/ride units 23 to be decoupled, failing which one or more carrier/ride units 23 may return to the launch station unlaunched. One sure way of going around this possibility is to have the beam coupling arms 18 connected together like an umbrella canopy and centrally controlled by one twine.

To be able to perform its function of rapidly descending with the escapee 84 to the ground, the carrier/ride unit 23 has a detachable personal shield called the “surfboard” referenced 75. The surfboard 75 is coupled with the launcher. FIG. 8A is a view of the surfboard 75. Designed with a launch seat 53, the surfboard 75 is equipped with handrails 54, footrests 55, and a harness 59. The surfboard shield 56, shields the escapee 84 from any objects around him during the high-speed descent, while the seatbelt-like harness 59 straps him to the surfboard 75. The surfboard is made of plastic or fiber material but it has a re-enforced central metallic core 52 which projects outward in the front of it in the form of a rectangular coupling head 50. Posteriorly, the central iron core 52 supports the launch seat 53. On the seat 53 and protected by the surfboard shield 56, the escapee looks much like a bike rider.

The launch pedal 60 has been discussed hereinbefore. It pops up from its recess when the surfboard 75 bears weight (of the escapee) as has been recited. The launch pedal 60 is the “push-start” button that unlocks the launcher FIG. 2A from the launch column 12 thus, initiating the Launch Mode characterized by the downward movement of the launcher. FIG. 8B shows the pedal input that unlocks the launcher from the launch column 12. It is the only input that the escapee 84 will make in a chain of events that will take place to evacuate him from the building: launch, deceleration, disengagement from the carrier/ride unit and ejection from the shaft 122.

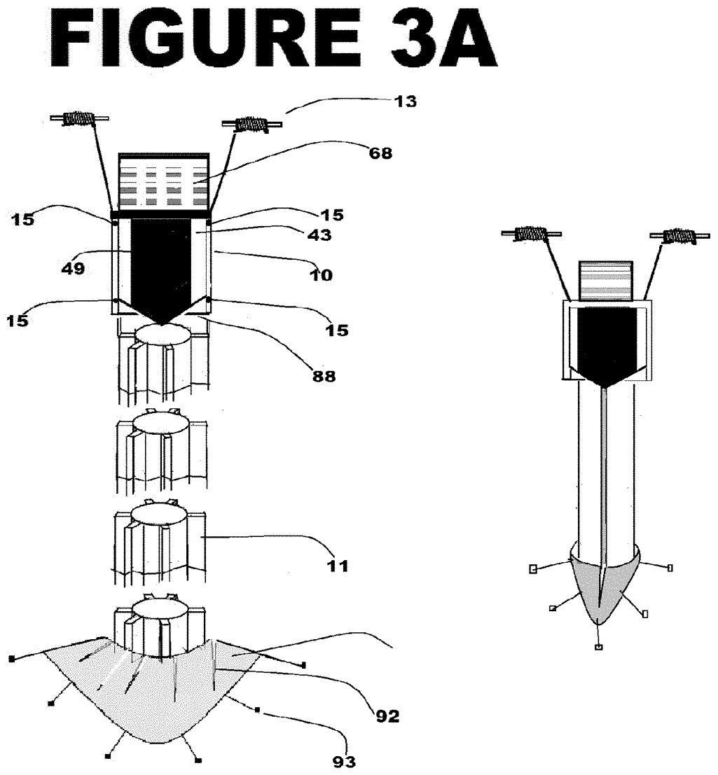

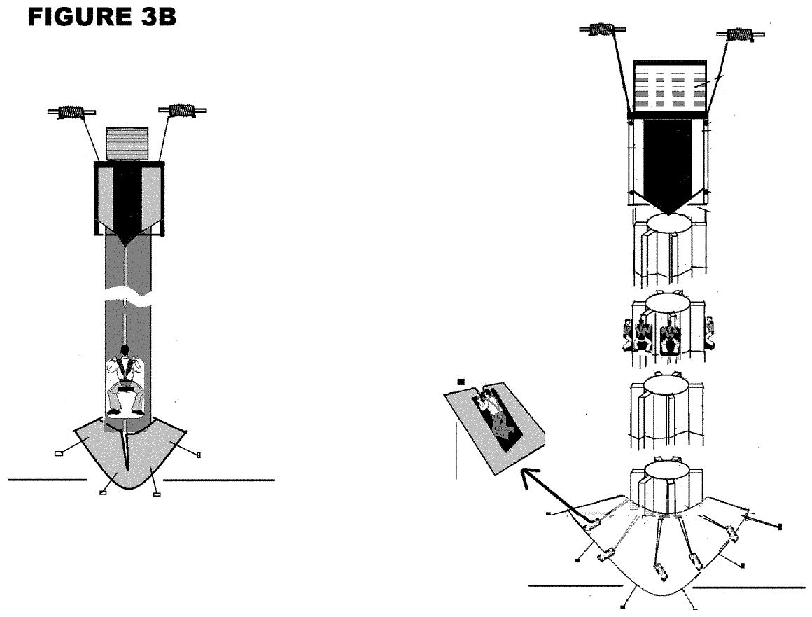

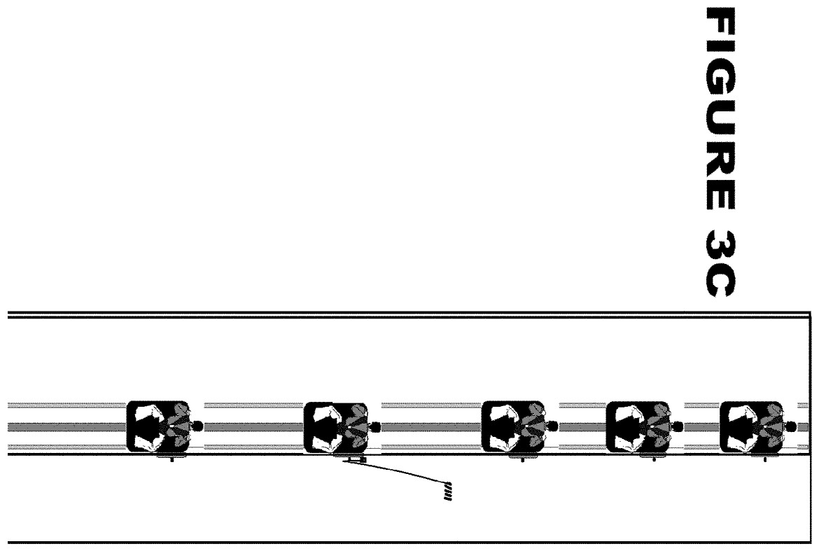

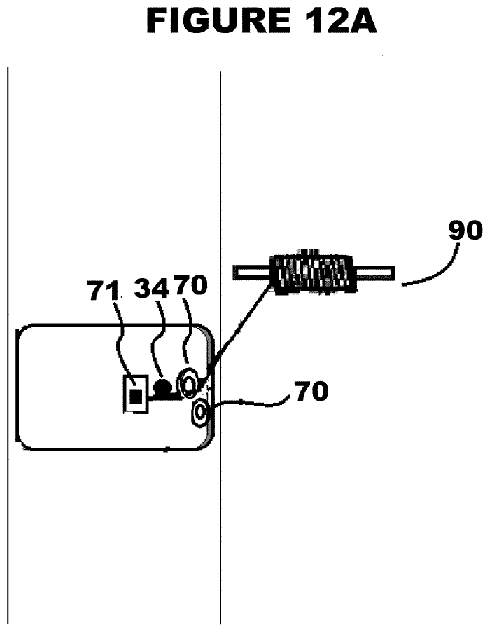

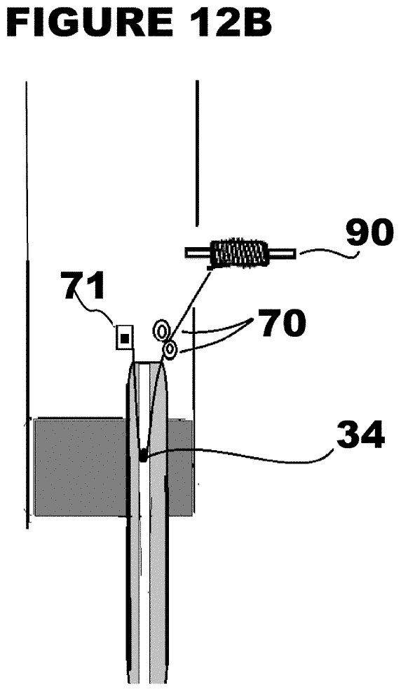

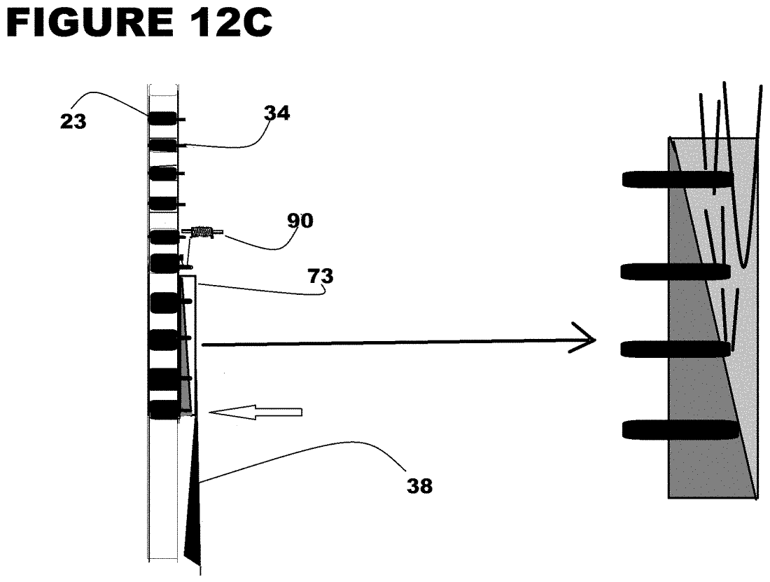

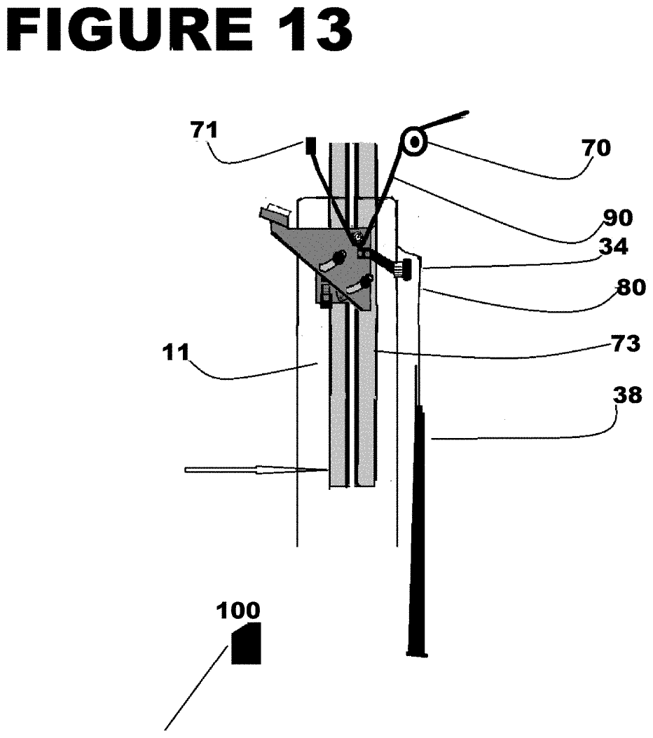

The carrier/ride unit 23 in flight is brought to rest by its brake assembly which comprises the primary (arresting rod and cable) and the secondary (brake lining and drum) brake systems. The primary brake system is designed to work off about 80% of the velocity of the ride unit, while the secondary brake system works off the rest, bearing in mind that heat is generated during a brake lining and brake drum mesh. The assemblage in action is portrayed in FIG. 3C, FIG. 12A, FIG. 12B, FIG. 12C, FIG. 13. I discuss it further herein, for the purpose of proper understanding especially as it pertains to the use of arresting cable 90 to brake the descending carrier/ride unit 23. First, it is my considered opinion that one arresting cable 90 can bring a descending carrier/ride unit 23 to rest. However, more than one cable 90 will be needed to individualize the brake power given a fixed distance for deceleration. This is simply the case because the differing weight categories likely to use the invention as an emergency escape system will call for variation in the brake power of the invention to suit the brake needs of each weight category. Second, recoil is bound to occur and certainly will be undesirable for smooth deceleration and subsequent ejection from the emergency evacuation system. I consider ejection a necessity for a system with short turn-around as undue delay will increase evacuation time; and thus, diminish the gains or advantages of the high-speed emergency evacuation system. Therefore, working off the cables 90 before recoil takes place for the purpose of even-braking is critical for ejection. In this embodiment, I have incorporated a row of arresting cables 90. In the default setting, the arresting rod 34 will impact only a cable 90 for the lightest escapee. A heavier escapee will call for a commensurate increase in the length of the arresting rod 34 as the hydraulic plunger 32 goes to work. This will cause the arresting rod 34 to impact more cables 90 as it extends across the row of arresting cables 90 and thus engender a greater amount of brake force. It is preferred that the row of arresting cables 90 be laid with the slider 73 below them as shown in FIG. 12C. The slider is a device I designed to work the arresting cables 90 off the arresting rod 34 while the arresting rod 34 is passing through it. The slider 73 is a long rectangular box—about the length of the “brake distance” of the primary brake system. It is divided into two right-angle triangles by a grooved plate, with the outer triangle inverted as shown in FIG. 12C. The plate that divides them is such that the groove is central, open at both ends and runs through the entire length of the box as shown in FIG. 12B and FIG. 12C. The groove allows the arresting rod 34 pass freely through the length of the slider 73 while stretching across the two triangles. The slider is affixed to the arresting rod-side of the launch pillar 11 with the central groove aligned with the arresting rod 34 in descent. During the interval, the arresting cable 90 is worked off the arresting rod 34 by the slanting plate as the arresting rod 34 progressively disappears into the inner triangle across the grooved plate as shown in FIG. 12C until the cable 90 is freed and thus, reels backward under the power of its spring load in readiness for another launch. This makes for safety as the slider 73 also acts as “engine-chain cover”.

The auxiliary brake system comprises brake linings 80 and brake drums 38 depicted in FIGS. 6A, 6B and 7B. The system kicks in to continue the brake action after the slider 73 has worked the arresting cable 90 off the arresting rod 34 to avoid recoil on the carrier/ride unit 23. While the brake drums 38 are mounted on the launch pillar 11, the brake arm 36 with its terminally-placed brake lining 80 is an appendage of the descending carrier/ride unit 23. Ordinarily, without load an imperceptible gap separates the brake lining 80 and brake drum 38. When the carrier/ride 23 unit bears load, the rotation of the load plate 40 causes the brake arm 36 to thrust forward. In this new position, it meshes the brake lining 80 with the brake drum 38 to cause brake action. Under the effect of the auxiliary brake system, the velocity of the carrier/ride unit 23 further retards to near zero meter/second necessary for safe disengagement of the surfboard 75 from the emergency evacuation device. Again, the weight-dependent rotation of the load plate 40 results in weight-dependent pressure head on the brake lining 80.

Though the brake distance is short, auxiliary braking as said before can and does produce heat during repeated launch. FIG. 6B, shows a cooler 39 incorporated to the drum 38 to absorb the heat. The cooler 39 is simply connected to the plumbing system of the building and is made of a rust-free material such as plastic.

It will be seen from the foregoing that the brake assembly individualizes the brake force by adding extra arresting cables 90 when a heavier escapee takes the launch seat 53. Similarly, heavier escapees engender a greater amount of brake force between the brake lining 80 and drum 38 by causing a wider angle of rotation of the load plate 40.

The Ejection Station is about one floor off the ground surface, the reason being to make provision for angulation necessary for a smooth and safe slide of the surfboard 75 and the escapee 84 with it. In its simplest form, the ejection station comprises two blocks 100 with shock-absorbing property such as rubber, mounted on the launch pillar 11 at the level where the slide will begin. The mount could be part of a metal structure that will suspend the tarpaulin canopy on which the slide will take place. The blocks 100 are positioned in the front of the launch pillar 11 about 30 centimeters apart and equidistant from the guide rails 27. Each has a slanting surface. The slant of the ejection blocks 100 and that of the tarpaulin 91 when installed are similar in orientation and degree. The positions of the blocks 100 are such that they will impact the reinforced/metallic upper part of the surfboard 75 when in rotation during Ejection Mode. Because each carrier/ride unit 23 has an independent ejection system, in multi carrier systems the ejection blocks 100 will tend to surround the launch column 12 and when the tarpaulin 91 is affixed to them and tethered to the ground by string and peg 93, the view becomes like that of a fanned-out umbrella. Onto each ejection unit a slit 92 is made on the tarpaulin 91 on the midpoint between the two ejection blocks 100. The guide slits 92 serve the purpose of having the surfboard hook 50 running in the slit 92. Typically, the slit 92 extend downward to about a meter to the tarpaulin's edge on the ground. The edges of the guide slits 92 are rimmed by folding them backward and stitching them together in order to strengthen the slit 92. FIGS. 3A and 3B show the invention with the ejection station depicted. In FIG. 3A, the slanting tarpaulin 91 is clearly shown with the guide slits 92 in place. FIG. 3B shows the invention in use during Ejection Mode with the carrier/ride units 23 guided downward by the slits 92.

Therefore, in this invention when there is fire or any reasons that call for prompt evacuation from the building, an alarm will sound, urging everybody to evacuate the building. Usually, lifts are shut down during fire incidences and therefore battery powered hand-held public address system urge people to the fire evacuation point. From the hallway, indicators on the floor FIG. 1A, point in the right direction. At the fire point, orderliness is encouraged. From a surfboard stack adjoining the evacuation area, surfboards 75 are distributed by officials along with tinted hoods for those who will need them. The surfboards 75 have extra harnesses 59 for parents riding with children because only persons weighing more than 30 kg—the hypothetical weight—can be launched safely considering the weight—dependent features of the carrier/ride unit 23 as recited hereinbefore. The children are strapped face-to-face to their parents who then harness themselves to the surfboard 75. An instruction in different languages concerning the use of the emergency evacuation device is affixed to the wall as part of the installation of the system. Mercifully, the system is user-friendly and the instructions are few and simple;
1. Insert the surfboard hook into its receptacle and listen for the catcher “click” sound. Pull to make sure!
2. Sit, harness in and use the foot rest and hand rail
3. Depress the pedal if applicable (after making sure that co-riders are seated and harnessed).

This message is repeated by the loud speakers at intervals.

In the case of one or two-carrier system, no operator is needed. In larger systems such as FIG. 10C, trained operators are responsible for launch after overseeing the procedure and making sure that prelaunch steps have been followed. One of the officials will be saddled with the task of using the launch pedal 60 while the others supervise and give the all-clear sign to him. His position is in an adjoining room separated from the launch room 10 by a perforated glass wall. A public address system is within his reach. Only the exact number that the system is designed for, are allowed into the launch room 10 with their surfboards 75. They quickly hook up to the system and harness 59 themselves in. In the interim, another set of escapees ready for the next launch bearing in mind that the system has short turn-around of only about two minutes. In systems with “gearwheel(s)” configuration, each compartment will be manned by an official or officials whose duty it is to supervise the prelaunch and announce the all-clear sign for launch to proceed. With a small number-carrier system only one position controls the pedal and the responsibility of overseeing prelaunch becomes that of the escapee 84 occupying that position. Again, for reasons of safety, the second escapee might be required to make a maneuver of his own when he is ready before the pedal input from the escapee operator can take effect. This is optional installation.

I will now discuss the mechanism of operation of the present invention. The mechanism of operation of this emergency evacuation device depends on the intricate interplay of the opposing forces of the launcher spring load overhead on the one hand and the launcher on the other. When the two opposing forces cancel out according to the present design, the launcher FIG. 2A, remains stationary in the launch station. A beam lock, preferably catcher-type 65, ensures that a downward movement of the launcher FIG. 2A, FIG. 2B does not become the case as additional weights (of escapees) are added. When all are harnessed and ready, the operator depresses the launch pedal 60 to unlock the launcher FIGS. 2A and 2B from the launch column 14. The launcher swings downward in the Launch Mode. The floor-lock actuators 49 roll up the ends of the angle iron 47 to unlock the movable floor 88 which gives way as the retractors 43 barge in-between the floor pieces. The carrier/ride unit 23 conveying the escapee 84, still engaged with the beam arm 18 passes through the maximally retracted floor 88 and the decoupler 22 runs out of length. It pulls the beam arm 18 away from its engagement with the carrier/ride unit 23 which becomes free of the launcher and rolls down the shaft 122 with its human cargo. Rid of the combined weights of the carrier/ride unit 23 and escapee 84, the odds are reversed and the launcher FIGS. 2A and 2B ascends back to the launch station 10, ready for the next launch. The movement of the launcher in the launch mode is depicted in FIG. 11C. Clearly, it demonstrates why the system has a short turn around.

Meanwhile, the descending carrier/ride unit 23 reaches the brake zone depicted in FIG. 13 and the arresting rod 34 impacts the arresting cables 90 designed to work off about 80% of its velocity. The primary brake system soon gives way as the brake linings 80 and drums 38 begin to work on the substantially reduced speed to bring the carrier/ride unit 23 to near zero m/s at the ejection station 100. The secondary or auxiliary brake system complements the arresting cables 90 by sustaining the brake action after the arresting cables 90 have been worked off, to avoid the inevitable recoil of the arresting cables 90 and thus, help to smoothen out the launch/ejection process.

The sequence of ejection is worth discussing. As the carrier/ride unit 23 gets to the ejection station, the surfboard undergoes a rotation to align itself with the slanting tarpaulin 91. The lower tip of the surfboard 75 is the first part to arrive at the ejection station and thus begins the process when it impinges on the slanting tarpaulin 91. Rollers 57 attached to the tip for the purpose (not shown) smoothen out the rotation. The rotation itself takes place on the surfboard rotation fulcrum or tilt fulcrum 51 which is shown in FIG. 8C. The tilt fulcrum permits up to a 90 degree rotation of the surfboard. It is between the surfboard central iron core 52 and the surfboard hook 50. The fulcrum enables the vertically coupled surfboard 75 to tilt to a horizontal orientation in a 90 degree rotation. Meanwhile, the upper section of the surfboard 75 continues to descend during the rotation. Close to the ejection blocks 100, the surfboard 75 and the carrier/ride unit 23 are disengaged when the load point catcher 25 is unlocked by the appendages on the launch column 12 (not shown). The surfboard coupling head 50 frees from its engagement with the carrier/ride unit 23 and rotates downward under its own weight. In the process, it dips into the guide slit 92. Aided by its rollers 57 and the guide slit 92, the surfboard 75, rolls down the slanting tarpaulin 91 with its coupling head 50 buried in the guide slit 92—another safety feature of the invention. When his feet touch the ground, the escapee manipulates the surfboard hook 50 out of the guide slit 92 and jettisons the surfboard 75 which is designed to be reused. The launch is over—for him. Meanwhile, the carrier/ride unit 23 continues to roll downward and ultimately falls off the guide rail away from the escapee as shown in FIG. 8C—another safety feature yet. To avoid possible entanglement of the carrier/ride unit 23 after ejection has taken place, the guide rail 27 below the ejection station can be manipulated to make the roller bearings 28 freer.

In consideration that launch will have to be multiple to completely evacuate all persons in a skyscraper, a carrier stack 68 is created to avoid undue delay. I have also considered the advantages inherent in automation as can be achieved without electrical power for the purpose of a conveyor belt-like operation with minimal human input.

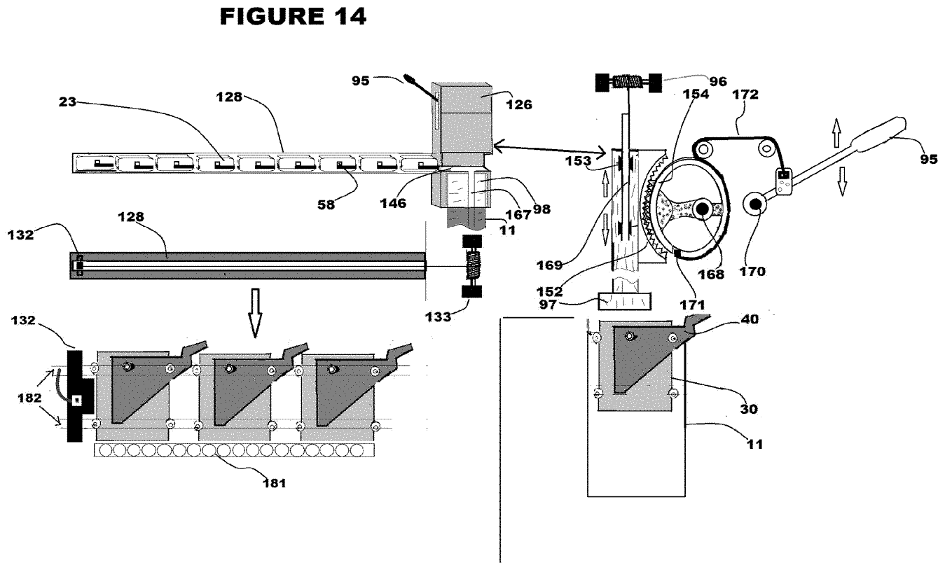

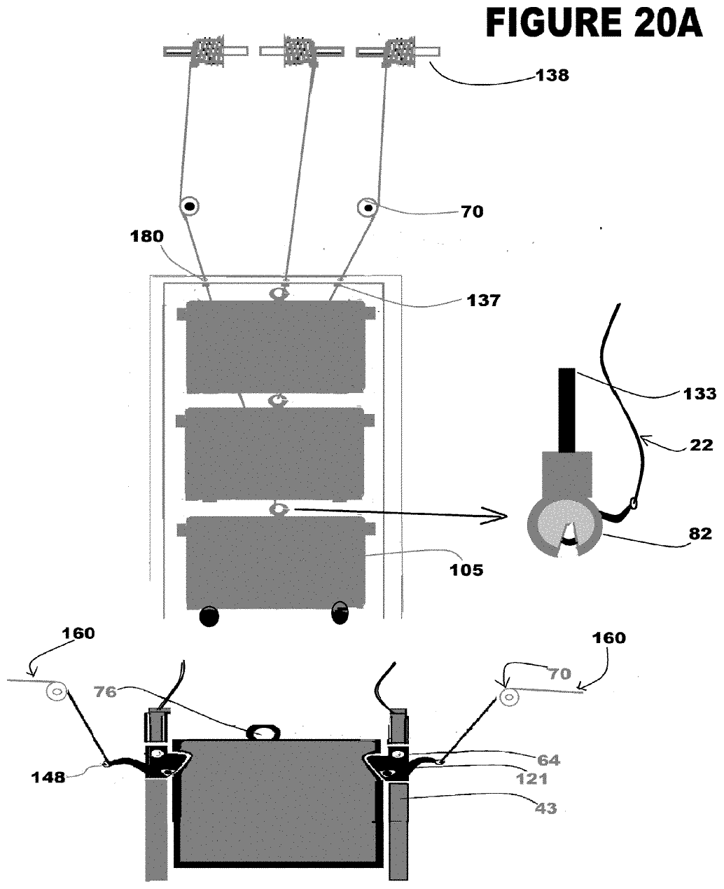

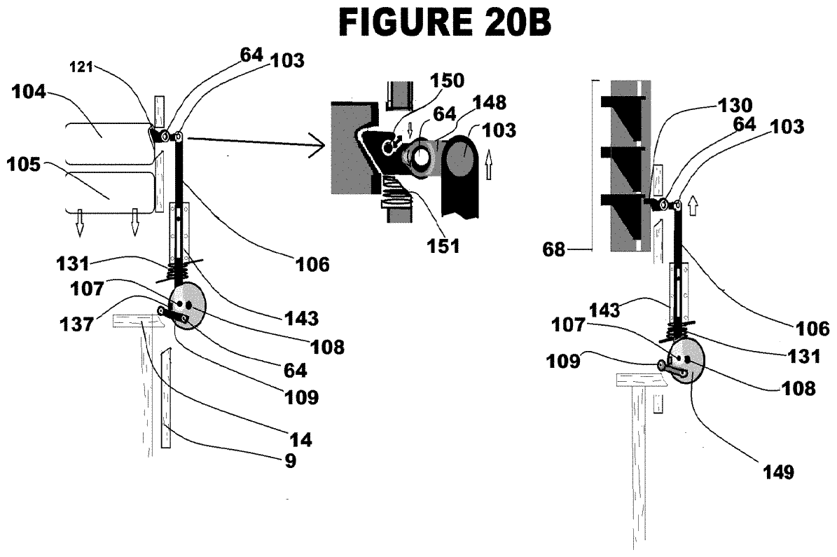

There are two replenishing systems that form part of the invention and I will now discuss them. FIG. 20B is called Self-actuation Carrier-Release Mechanism (SACREM), a system I designed to self-unlock another carrier/ride unit 23 (or an emergency escape cabin of a second preferred embodiment) to roll down into position from the stack 68 after each launch, without the escapee 84 carrying and connecting his own surfboard or even togging at a rope to make the surfboard descend into position. Equally, in the pursuit of a system that is self-operating to large extent, I also considered and designed a Carrier Loader or Carrier Chambering Machine shown in FIG. 14 to “chamber” carrier/ride units 23 into the system from an external source, as the stock on the stack 68 depletes.

The two mechanisms, designed to facilitate multiple launches will now be discussed. First, to create a stack 68, the launch pillar 11 or launch column 12 will be made to rise above the beam 14 to contain the stack 68 depending on the size of the emergency evacuation system and the number of launch rounds worked out for complete evacuation of the building. A carrier stack 68 is depicted in FIG. 3A. The ride units have an intervening space between them made possible by using space maintainer shown in FIG. 20B. The release mechanism is launcher-actuated. During a launch round and as the launcher swings back to the launch station 10, an appendage attached to the beam 14 impacts an actuator 109 which has a fulcrum 64 on a revolving wheel 149 which also provides a fulcrum 107 for a carrier release arm 106. In FIG. 20B, the actuator 109 has a stopper 137 above it which enables it engage the wheel 149 in that direction without which it will turn 360 degrees freely on its fulcrum 64. The carrier-release arm 106 has a common joint 103 at its distal end with the hanger catcher release lever 148. The lever 148 actuates the hanger catcher to dissociate from the lock pin 150 installed on the shaft 9 or metal framework 86 therein, to lock the hanger 121 to the shaft 9 and thus prevent the carrier stack 68 or the emergency cabin from descending from their positions until desired. The arm 106 is held in position by the revolving wheel 149, an anchoring plate 143 with a shifting bolt or rivet that holds the release arm 106 to the plate 143 while making allowance for the movement of the arm 106 in the vertical plane as shown in FIG. 20B, and partly by the catcher lever 148. The hanger 121 has a fulcrum 64 which anchors it to the shaft 9 or the metal framework 86 therein, and enables its vertical rotation necessary for its operation as a lock. And so, as the returning launcher impacts the release actuator 109 in an upward direction, it causes it to engage the wheel 149 as a result of the stopper 137 and an upward movement of both the wheel 149 and the release arm 106 takes place with the arm 106 working the catcher lever 148 to release the hanger lock. Under the weight of the carrier stack 68, the hanger 121 rotates downward and outward against the return spring 151 which does not counterbalance the weight of the carrier stack 68. As the first carrier/ride unit 23 passes through, the gap between it and the next provides a temporary relief of the downward pressure on the hanger 121 which quickly snaps back into the lock position under the power of the return spring 151 and once again keeps the stack 68 suspended on the shaft 122. Meanwhile, the unlocked carrier/ride unit 23 rolls down to the launch room/station 10, in readiness for the next launch. It must be noted that the carrier lock takes advantage of the gaps between the carrier/ride units 23 much like cogs in a gearwheel, without which the entire stack 68 will tend to roll down unimpeded. The interaction between the beam 14 and the carrier-release actuator 109 is a brief one as the beam 14 soon passes on causing the release of only one carrier/ride unit 23. Meanwhile, the return spring 131 rolls back the wheel 149 to its previous position. The release actuator 109 does not have a stopper 137 below it and therefore its downward rotation as the launcher goes again to launch is inconsequential. A return spring (not shown) returns the actuator 106 to its original position when the launcher has passed. Tugging at a rope (not shown) to cause the release of another carrier/ride unit 23 remains an alternative maneuver but in an emergency situation especially when every second counts, automation can be an advantage and the Self-actuation Carrier (or cabin)-Release Mechanism (SACREM) FIG. 20B, and the Carrier Loader FIG. 14 will certainly improve the effectiveness of the evacuation process by reducing hands-on and turn-around.

The Carrier Loader shown in FIG. 14 has the sole purpose of “chambering fresh rounds” of carrier/ride units 23 into the Emergency evacuation device to meet the demand of the automated launcher, during an emergency. The Carrier Loader 126 is incorporated to the invention above the stack 68, with an extension made on the launch pillar 11 as well as on the guide rails 27 to go with it. The Carrier Loader 126 is connected with the launch pillar 11 from below it. And from the chambering table 146 above the carrier/ride units 23 are fed into an aperture 98 which is devoid of guide rail 27. The aperture 98 only serves to align the carrier block 30 for the next stage of the chambering process—the “pile drive”. To avoid the encumbrance of the load plate 40 in the chambering process, the aperture 98 has a groove 167 by the side like the launch pillar 11 below it and both grooves are in alignment. The cross plate 101 runs in the groove and the load plate 40 on the outside of the aperture where it will not encumber the chambering of the carrier block 30. The chambering table 146 has an orifice for the purpose of connecting up a prefilled carrier “magazine” 128. A spring loaded cable 133 mounted inside the Carrier Loader has the free end of the cable affixed to a draw plate 132 mounted on a guide rail 182 inside the carrier “magazine” 128. The draw plate 132 is positioned behind the last carrier/ride unit 23 and by the power of the spring load 133, ensures that the row of ride units 23 is drawn forward aided by floor-mounted rollers 181 to the chambering table 146. A stopper (not shown) ensures positional accuracy before a manually driven loading piston 97 forces the carrier block 30 down the aperture 98 which aligns it with the carrier guide rails 27, and into the launch pillar 11. The loading piston 97 is a metal block suspended above the chambering table 146 by a spring loaded cable 96. The said piston 97 is made to run on a guide rail system 169 that enables it rise above and descend below the chambering table 146. A vertically-positioned gear 152 attached to the piston 97 enables it mesh with a drive gearwheel 154 which has a fulcrum 168. One half of the wheel carries the gear 152 while the other is forged with a pulley on it and a pulley rope 172 attached to a point 171 on the gearwheel. The drive gearwheel 154 is of sufficient circumference that a single “crank” from the loading handle 95 chambers one carrier/ride unit 23. When the last carrier/ride unit 23 has been chambered, the draw plate 132 impinges on a lever (not shown) which disconnects the spent “magazine” 128 from the Carrier Loader 126. The spent “magazine” 128 is replaced and the replacement hooked up with the spring-loaded cable 133.

The launch room door lock is worth discussing. The launch room door opens to the outside because of the moving structures inside the launch room 10. A door handle on either side controls movement of the door in the open direction while a return spring connected to it ensures that it closes on its own accord when left open. The door handles have no effect on the door lock. Instead, the door lock is controlled by the launcher which in the descending mode turns a latch that locks it down and prevents it being opened while in operation. The reverse becomes the case as the launcher ascends back to the launch station 10.

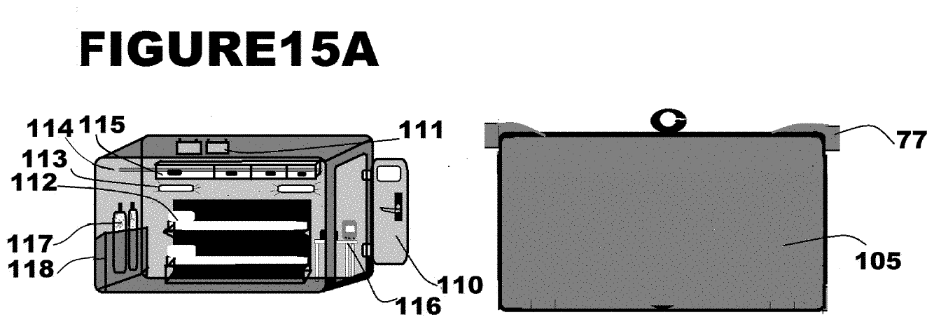

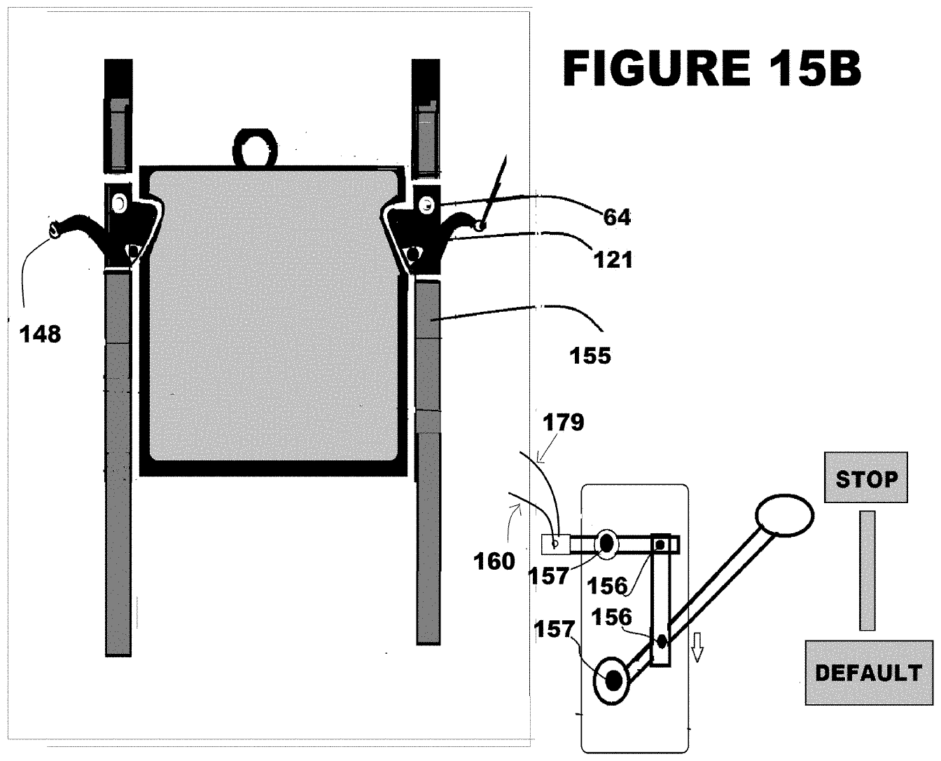

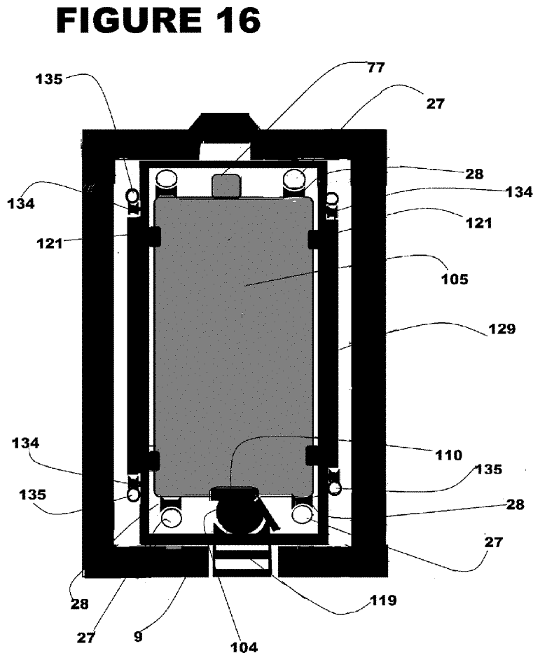

The second preferred embodiment of this invention is an emergency escape cabin referenced 105 which is shown in FIG. 15A and FIG. 16. It is designed for escapees that have existing ailments such as high blood pressure, heart disorder, epilepsy, burns or persons rendered unconscious by the present emergency situation. The health conditions—depending on the degree—may warrant that such persons are deemed unfit to use the first preferred embodiment as an emergency escape system. Also, unaccompanied children can ride in the second preferred embodiment.

The emergency escape cabin 105 preferably is rectangular in shape and of such height as to accommodate a man standing erect. The emergency escape cabin 105 contains a vertical row of beds 112 for the wounded or unconscious. On the alternative, seats can replace the beds 112. The emergency escape cabin 105 also contains emergency equipment such as a defibrillator 116, oxygen cylinder 117 and masks, blood pressure apparatus and First Aid kits. Roof-mounted batteries 111 provide illumination 113 and power for other essential needs. An overhead handrail 114 is installed to harness care givers to the cabin 105 while launch is ongoing. The emergency escape cabin 105 is made of light weight material such as plastic with metal struts where strength is needed. It has a door 110 on one side of its shorter axis. At the bottom in the mid-point of its long axis, a round metallic structure projects outward on either side. This is the arresting rod 77 designed to catch the arresting cables 90 during descent.

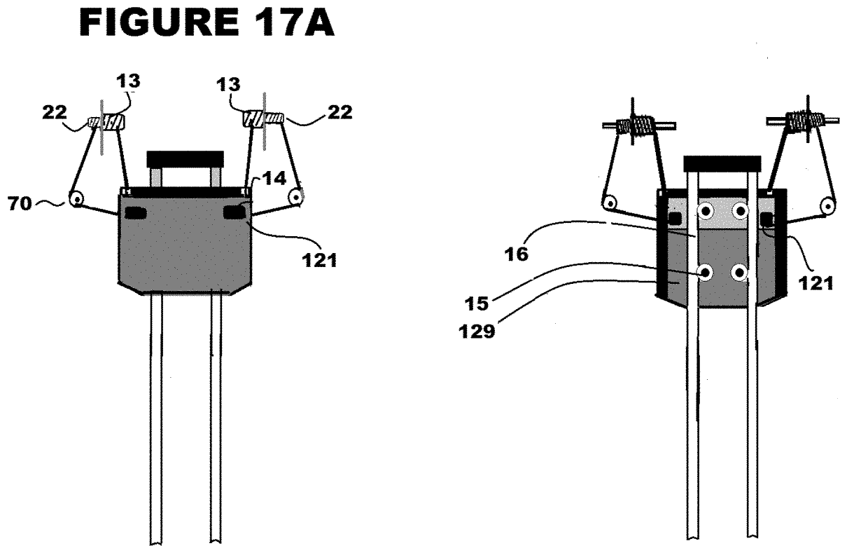

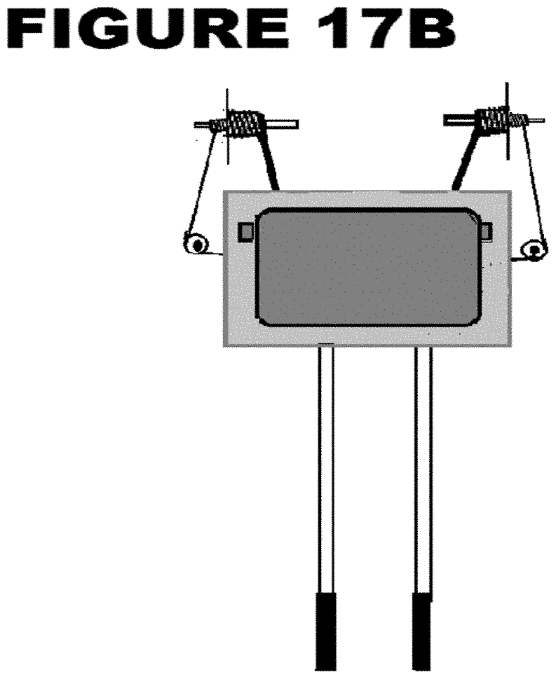

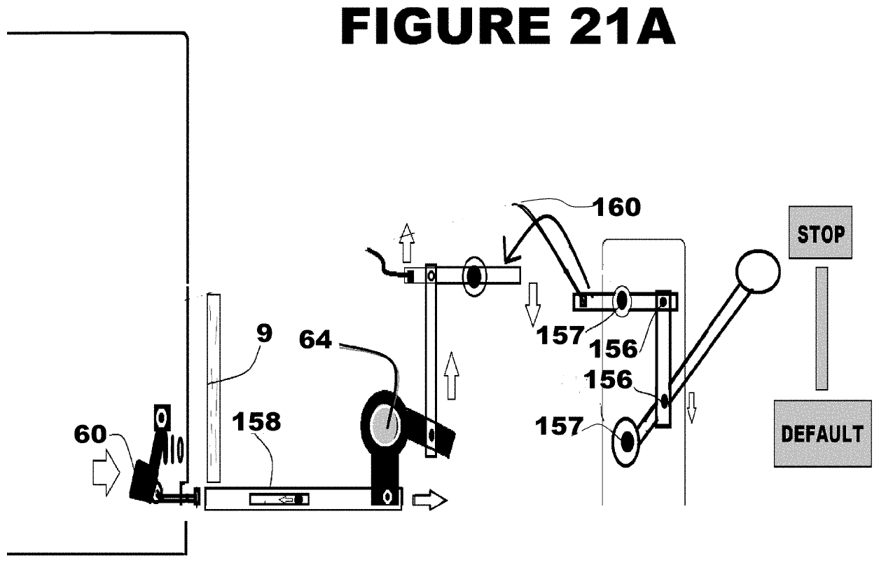

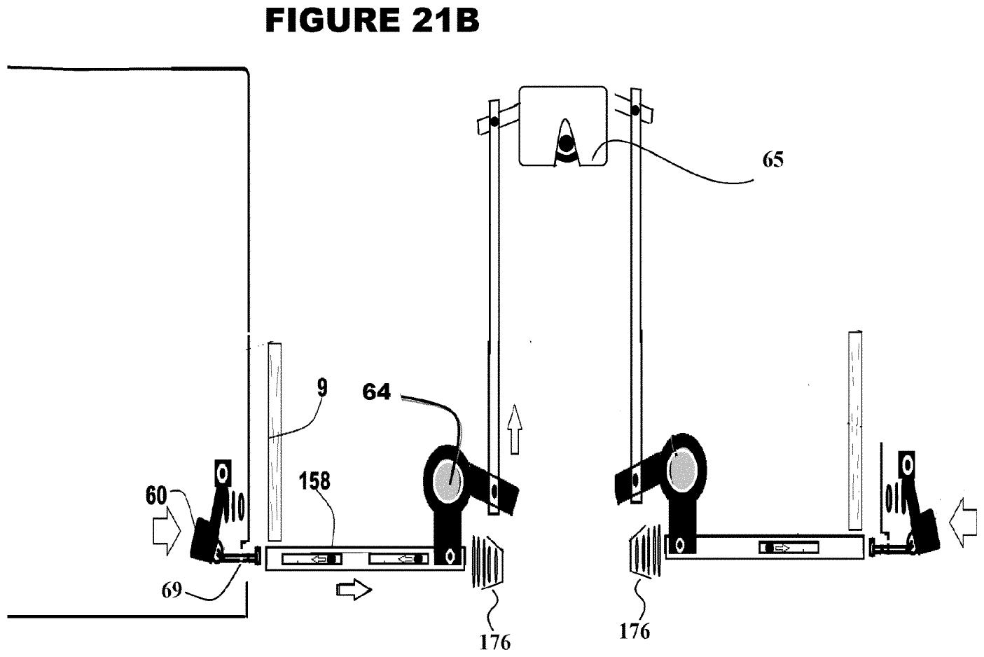

The emergency escape cabin 105 operates much like the first preferred embodiment, with a launch station 10 and a launcher. However, unlike the first preferred embodiment, there is no retractable floor 88 and therefore no retractors 43 or floor-lock mechanism. Here the launcher comprises a beam 14 and two launch boards 129 that are connected much the same way as the floor retractors 43 of the first preferred embodiment. FIG. 17A shows the launcher of the second preferred embodiment. The launch boards 129 have roller bearings or beam rollers 15 affixed to their backsides and the beam rollers 15 securely run on guide rails 16 provided and similar to the beam roller guide rails 16 of the first preferred embodiment. A beam lock 65 (not shown) secures the launcher to the metal framework 86 of the invention until launch is approved. Claw-like hangers 121 shown in FIG. 15B, and FIG. 17A are installed on the launch boards 129 and they dig into depressions or coupling points on the cabin to enable the emergency escape cabin 105 remain suspended on the launcher prior to launch. The coupling points are created on the strong areas of the cabin while considering maximum stability and unimpeded access to the interior of the emergency escape cabin 105. The hangers 121 are retractile, with a fulcrum 64 for vertical rotation. A catcher is incorporated to the hangers with a lock pin 150 anchored on the interconnecting metal framework 86. The hangers 121 are in the locked (ON) position at Idle Mode according to the default and they keep an emergency escape cabin 105 suspended on the launch boards 129 at the launch station 10 at the ready as shown in FIGS. 17B and 15B. It is worthy of note that this setting is the opposite at the floor-level hangers 121. The decoupler 22, discussed in the first preferred embodiment when it comes to launch, also applies here. The decoupler 22 is attached to the cabin hanger release levers 148 and works the launch board cabin hanger 121 to decouple the emergency escape cabin 105 and the launcher. Again, in similarity to the first preferred embodiment, a foot pedal 60 is incorporated for the purpose of initiating launch from within the emergency escape cabin 105. The initiation of Launch Mode from within the emergency escape cabin 105 and also by officials in the building is made possible by a dual launcher-release mechanism shown in FIG. 21B which employs a push rod 158 and a set of levers that mesh with the cabin-mounted launch pedals 60 to initiate launch.

The downward decent of the launcher during the Launch Mode is terminated by the decoupler 22 which disengages the emergency escape cabin 105 from the launch boards 129, by working the cabin hanger lock release lever 148 to cause the said disengagement. Under the weight of the cabin 105, and against a return spring 151 the hanger undergoes a downward and outward rotation and thus, frees the emergency escape cabin 105 to roll down the shaft 122. Rid of the weight of the emergency escape cabin 105, the return spring 151 snaps the cabin hanger 121 back to the lock position as the launcher ascends to the launch station 10 in readiness for the next emergency escape cabin 105 from the stack 68.

As mentioned hereinbefore, the emergency escape cabin 105 has a door 110 on its shorter axis. Ordinarily, a permanently-installed gangway can bridge the gap between the building and the emergency escape cabin 105. But the gangway will impact the arresting rod 77 as shown in FIG. 16 with the cabin door open. If properly worked out, the gangway 119 will not be more than one foot or 30 cm across gap and therefore can become a right-angled extension of the cabin door 110. When the door closes, the door-attached gangway slides under the floor of the cabin 105 where it impinges on and aligns the launch pedal 60 with the catcher release push rod 158—see FIG. 21B—for the necessary interaction between the two without which the launch pedal 60 will not mesh with the push rod 158 to unlock the launcher from the beam lock 65.

It is important at this point to discuss the cabin stack 68 of the emergency escape cabin 105. Like the first preferred embodiment, the emergency escape cabin 105 has a cabin stack 68 as shown in FIG. 20A, in the foreseeable circumstance that one launch might not serve the purpose of complete evacuation of the stranded on the skyscraper. The stack 68 is suspended and controlled by the Self-actuation cabin release mechanism (SACREM) shown in FIG. 20B which has been discussed hereinbefore as it relates to the first preferred embodiment. The difference here is that each cabin 105 has its winch point 76 locked on to the end of an anti-jar spring loaded cable 138 hung overhead as shown in FIG. 20A, which partly takes the weight of the cabin 105 off the stack hanger 121. The lock 82 is the catcher type and it is worked by a decoupler 22. The work of the spring load 138 is to gently lower the emergency escape cabin 105 on to the launch board hanger 121 to prevent jarring impact. The stack decoupler 22 unlocks the emergency escape cabin 105 from the spring loaded cable 138 at the precise moment. When a disconnection has been achieved by the stack decoupler 22, a cable stopper 137 prevents the cable reeling back beyond necessary for ease of connecting up the spent cabins 105 on the stack 68 later when the emergency is over.

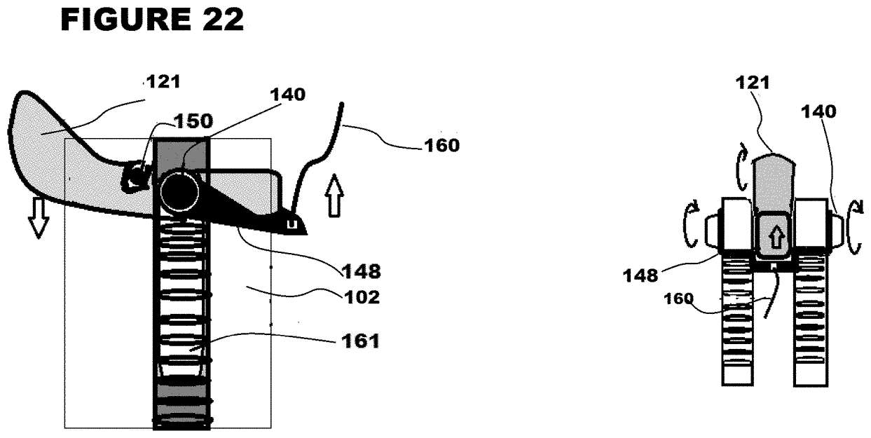

Unlike the dedicated shaft 122 of the first preferred embodiment, the shaft 122 of the second preferred embodiment has an access point with a door created at each floor leading to it. The emergency escape cabin 105 is designed to make stopovers along its path of descent when such demand is made of it. A structure called docking board 155 is affixed at the floor-levels where stopover will happen. The docking board 155 works in pair and as such, resembles the launch boards 129 without the rollers. They have hangers 121 as well for the purpose of suspending the emergency escape cabin 105 in the shaft during stopover. The floor-level (stopover) hanger 121, unlike the hanger 121 installed on the upper levels, is modified by having springs 161 beneath it—as shown in FIG. 22 This is to cushion the shock arising from the stopover of the emergency escape cabin 105. The hangers 121—preferably four in number like the others—interact with the emergency escape cabin 105 at the same points as the hangers 121 installed on the launch station 10 and the cabin stack 68. These stopover hangers are controlled by a Cabin Hanger Control Unit (CHCU) shown in FIG. 15B which is installed at each floor level to make stopover possible. In default, the stopover hanger 121 works in the opposite to the hanger 121 on the launch station, and this is as a result of the Cabin Hanger Control Unit. The default is that the control unit has its handle in the down position and in that position, it will taut and work a control cable 160 linked to its hanger release lever 148 of the docking board or stopover hanger 121 to unlock it and keep the hanger that way, unless reversed by the control unit. A descending cabin 105 thus passes through without making a stopover. The STOP setting slacks the cable 160 and the hanger lock kicks in. Thus, the cabin hanger 121 stiffens out like the flap of an aircraft to receive the descending emergency escape cabin 105.

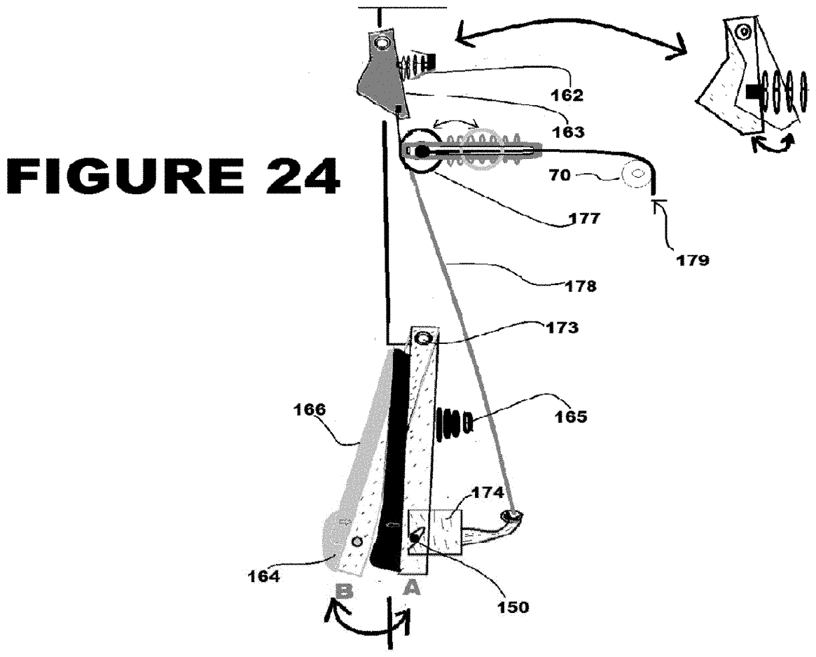

As has been said, the floor-level or stopover hangers 121 are mounted on powerful springs 161 to cushion the impact of the stopover. FIG. 22 shows a typical stopover hanger. Two metal blocks 102 with vertical tubular opening provide niche for the cabin hanger spring 161. Rectangular grooves on either side of the metal block 102 would enable the cabin hanger springs 161 to provide support for a center rod 140 sitting on top of the springs and across the intervening space between the blocks 102 through the grooves. The cabin hanger 121 is fitted in the intervening space with the center rod 140 passing through it and providing it with needed stability and fulcrum for its operation. The rod 140 is circular in shape but takes the shape of the rectangular grooves within the metal blocks 102 to enable its anchorage in the grooved metal block 102 without rotation. Its free circular ends become the fulcrum of the hanger catcher lever 148 which finds union with the hanger catcher in the midline as depicted in FIG. 22. Though anchored in the grooved blocks 102, the center rod 140 is mobile in the vertical axis as the two supporting springs 161 determine, when the system bears load. That is to say, that the rectangular grooves allow the center rod 140 to spring down and up during operation with the hanger locked to the lock pin 150. The center rod 140 and the hanger 121 are able to move in unison because the cabin hanger lock pin 150 is also anchored to the center rod 140 in the front of the cabin hanger 121. The release lever 148 works the hanger lock from below the hanger 121. Because of its design, when the hanger release lever 148 is caused to rotate in the upward direction, it not only unlocks the hanger catcher but also impacts the shaft end of the hanger 121 close to it and causes a rotation of the hanger 121 in the downward direction. The stopover hanger 121 thus, retracts from the path of descent of the emergency escape cabin 105 in the process. FIG. 21A shows the Cabin Hanger Control Unit (CHCU) and the control cable 160 linking it with the cabin hanger control lever 148. The CHCU does not only control the cabin hanger 121; it also controls the auxiliary brake system of the emergency cabin 105. Like the first preferred embodiment, the emergency cabin 105 has brake linings 80 (not shown) attached to its long axis which are designed to mesh with brake drums 166 shown in FIG. 24 and mounted on the shaft 122. The brake drum 166 is retractile. Also, it is cabin-actuated when put on brake-ready mode by the Cabin hanger control unit. FIG. 24 shows the auxiliary brake system of the emergency escape cabin 105. Mounted on a long metal base with a fulcrum 173 at one end of it, the drum 166 does angulate forward as a result of a spring power 165, mounted at the other end to cause the said angulation when in use. The default setting is that the movable end is locked down by a brake drum catcher 174 installed on the metallic framework of the invention. In this position, it does not mesh with the cabin brake lining 80 and therefore, the emergency escape cabin 105 experiences no stopover brake action while descending down the shaft 122. The brake drum catcher 174 is controlled by the drum release cable 178 affixed to a drum-release button 163 positioned higher up in the shaft 122. When stopover is desired, the Cabin Hanger Control Unit FIG. 15B discussed hereinbefore performs two critical functions to aid the stopover; 1. It relaxes the tension on the cabin hanger lever 148 through cable 160 to lock the cabin hanger 121 in readiness to receive the emergency escape cabin 105 as discussed hereinbefore, 2. With the tension on the adjuster cable 179 eased also by the cabin hanger control unit, the adjuster 177 springs forward and partially tensions the drum release cable 178. It is to be understood that both the adjuster cable 179 and the hanger catcher release cable 160 have the same attachment point and therefore react to the movement of the Cabin Hanger Control Unit (CHCU) in the same manner. However, the tension created by the adjuster on cable 178 comes short of the working tension required to operate the brake drum catcher 174 which is designed to operate at a much greater tension; it merely puts the drum-release cable on work-ready mode. And so when the descending emergency escape cabin 105 depresses the brake drum release button 163 the required tension on the drum release cable 178 is met and the brake drum catcher 174 is worked. The movable brake drum 166 is released and angulates forward to the mesh position. The descending emergency escape cabin 105 meshes with the brake drum 166 and comes to a stop at the desired floor level. A brake drum lock knob 164 locks the angulated brake drum 166 back to its default position as the emergency escape cabin 105 passes through the entire length of the brake drum 166 to stop on the cabin hanger 121. Thus, like the first preferred embodiment, the arresting cable 90 and the auxiliary brake system work in concert to bring the emergency escape cabin 105 to a stop. It is my recommendation that both the brake drum 166 and the brake lining 80 be installed with coolers for maximum heat control.

To stop the emergency escape cabin 105, all that a would-be escapee or official needs to do is to break an encasing glass box and turn the CHCU control handle to the STOP position. As said earlier, this will relax the tension on the common cable 160, and allow the cabin hanger 121 to snap back to the LOCK position. The same CHCU maneuver puts the stopover brake system of the emergency escape cabin on the standby or work-ready mode. The official or escapee will now wait for the descending emergency escape cabin 105 to arrive and make a stopover, like a lift. Thus, it becomes understandable that a particular floor can have a cabin 105 sent to it directly from the stack 68 on request, with the aid of the CHCU, without making a stopover at other floors. Certainly, this phenomenon will eliminate the need for dedicated shafts if desired as the only issue to deal with will be that of coordination: with enough cabins 105 on the stack 68, during emergency, cabins 105 are sent down to the floors from before backward. The order of launch will be the lowermost first and the topmost last. The Cabin Hanger Control Unit (CHCU) FIG. 15B can be manipulated from within the emergency escape cabin 105 to disengage the emergency escape cabin 105 from the launch station 10. FIG. 21B shows the application of the modification to work and secure (from within the cabin) the Launch Mode by disengaging the launcher from the beam lock 65. At floor level, the same adaptation as shown in FIG. 21A will also unlock the stopover hanger 121 to initiate resumption of the downward motion of the emergency escape cabin 105.

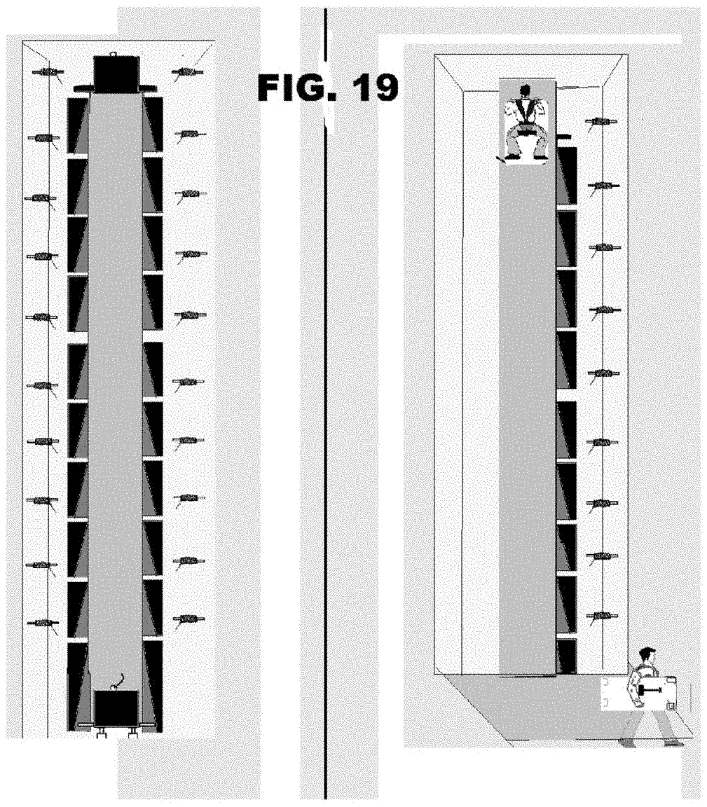

It is important to understand the role of the arresting cable 90 as it differs in this embodiment from its role in the first preferred embodiment. To have the emergency escape cabin 105 descend at a slow and substantially constant velocity, arresting cables 90 are used in a slightly different arrangement. In this embodiment, the aim is to put the emergency escape cabin 105 under constant brake force while descending down the shaft 122. Unlike the first preferred embodiment of this invention, wherein the arresting cable 90 works off about 80% of the velocity of the carrier/ride unit 23 within a short distance, in this embodiment, arresting cables 90 work together with sliders 73 to realize the goal of a slow, substantially constant descent velocity. The arresting cable 90 and a slider 73 are paired and thus, work as a unit to generate and terminate a brake force. Several units are laid down the shaft 122 at intervals decided by the predetermined velocity of the emergency escape cabin 105. The velocity of the emergency escape cabin 105 will then depend on the following variables: the interval between the brake units, the “brake distance” that is, the period of engagement of the brake units, the strength of the arresting cable spring load and the weight of the emergency escape cabin 105. The weight of the cabin is removed from the list by computing the predetermined speed with the weight of a fully-loaded cabin 105 as can be envisaged during an emergency. A longer brake zone or a weaker arresting cable spring load, and a longer brake interval will all mean a faster emergency escape cabin 105. The reverse is the case when slow, controlled descent is required; a situation that more effectively deploys the arresting cable/slider brake units as “speed check”. FIG. 19 shows cable/slider brake units in action as each unit engages the emergency escape cabin 105 briefly, and literally speaking, hands the “cabin baton” over to the next and the next to the next, until the last unit working in concert with the brake drum 166 and brake lining (not shown), provides the final sustained brake action necessary to bringing the descending emergency escape cabin 105 to a stop. The “slider effect” can be mimicked by slanting the arresting rods backward (upward) to create a situation where the cables slide off the descending arresting rod on their own. From the foregoing description, it becomes clear that the emergency escape cabin 105 will not descend in stops-and-starts, but rather with controlled substantially uniform velocity which will depend on the factors hereinbefore listed.

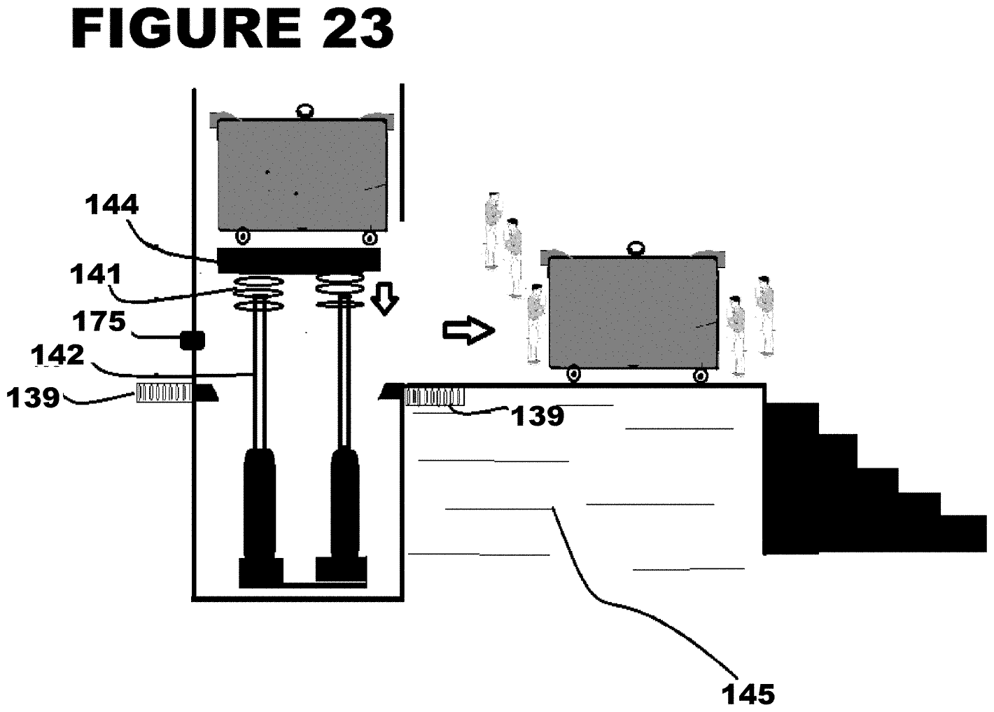

In summary therefore, during an emergency such as a fire, fire fighters are called and while the evacuation of the survivors is ongoing, the wounded, the sick and others deemed unfit to use the first preferred embodiment for emergency rescue are identified. They are taken to the emergency escape cabin section of the fire evacuation point where they are made to sit or lie inside the emergency escape cabin 105. Caregivers are involved. When the door 110 is closed, it aligns the launch pedal 60 with the hanger catcher release push rod 158. The operator depresses the pedal 60 which now meshes with the pushrod 158, works the catcher to secure the release of the hangers 121 and thus, initiates the Launch Mode. Equally, the emergency escape cabin 105 can be launched by an operator inside the building. As the launcher descends with the emergency escape cabin 105, the decoupler 22 disengages the emergency escape cabin 105 from the launcher soon after and the cabin 105 descends down the shaft 122. Floor-level officials decide whether it will stopover or make an uninterrupted descent through a particular floor. Ultimately, the emergency escape cabin 105 comes to a final stop at the ground station. The ground station shown in FIG. 23 comprises two platforms each serving a different purpose. The emergency escape cabin 105 comes to a final stop on the mobile platform 144 which is designed to free the ride unit from the guide rail 27. The mobile platform 144 is an ejection system of sorts. The platform has springs 141 to absorb the shock of the landing of the emergency escape cabin 105. Hydraulic Lifters 142 which support the platform 144 are designed to raise or lower the platform 144 depending on the weight placed on them. Under the weight of a loaded cabin 105, the platform 144 retracts downward to a point below the guide rails 27. In the process the mobile platform 144 impinges on a one-way lock system 139 that locks down the platform 144 and allows the emergency escape cabin 105 to be rolled or winched aside onto the concrete platform 145. When loading the empty cabin back onto the platform 144, the emergency escape cabin 105 will impinge on a push-release knob 175 which will unlock the platform 144. The platform 144 will then rise with the empty cabin 105 under the hydraulic pressure to the platform's default position. When multiple launches are ongoing, a provision enables the operators to unlock the empty platform 144 after a cabin lands. The empty platform 144 will then rise, in readiness for the next emergency escape cabin 105.

When the emergency is over and electricity supply restored, the emergency escape cabin 105 is winched up by an electric motor attached to the winch point 76, where maintenance officers rig up the stack decoupler.

From the foregoing recitations, certain deductions and or conclusions can be made concerning the first and second preferred embodiments of the present invention.

1. The emergency escape cabin 105 can ride normal passengers or escapees. That is, it can replace the first preferred embodiment as an emergency evacuation system.

2. The emergency escape cabin 105 can function as One-way lift, able to make floor-level stopover at normal times, where electricity supply has been interrupted or when the lift is not functional.

3. The first preferred embodiment can have cable/slider brake units incorporated to it for the purpose of speed control, as shown in FIG. 19.

I find it necessary to include the standard pilot lights for lifts to aid the smooth operation of this invention. This will not contradict the claim of no-electricity-required launch. Three LED lights are mounted on the top of the door frame as shown in FIG. 1A: Red, Amber and Green. They derive their power supply from a dc power source such as inverter battery with a solar panel on the roof to charge the battery as shown in FIG. 1B. At Idle Mode in the launch room/station 10 the Green light is on. In the Launch Mode, it changes to Red and turns Amber when beam-carrier disengagement has taken place. Back in the launch room 10, the Green light lights up again.

| REF. | |
|---|---|
| NUMBER | REFERENCE PART |
| 9 | CONCRETE SHAFT OR METAL SHAFT |
| 10 | LAUNCH ROOM/LAUNCH STATION |
| 11 | LAUNCH PILLAR |
| 12 | LAUNCH COLUMN |
| 13 | LAUNCHER SPRING LOAD |
| 14 | LAUNCH BEAM |
| 15 | BEAM ROLLERS (PREFERABLY 8 NOS) |
| 16 | BEAM ROLLER GUIDE RAIL |
| 18 | BEAM ARM (BEAM COUPLING ARM WITH |
| | CARRIER/RIDE UNIT) |
| 19 | RETURN SPRING FOR BEAM COUPLING ARM |
| 20 | BEAM ARM FULCRUM |
| 21 | BEAM ARM RETURN SPRING |
| 22 | DECOUPLER (DECOUPLING ROPE) |
| 23 | CARRIER/RIDE UNIT |
| 24 | CARRIER/RIDE UNIT ROLLER ARM |
| 25 | LOAD POINT CATCHER |
| 26 | UNLOCK (CATCHER) APPENDAGE |
| 27 | CARRIER GUIDE RAIL (2Nos)/EMMERGENCY |
| | CABIN GUIDE RAIL (4Nos) |
| 28 | CARRIER ROLLER (PREFERABLY 4 Nos)/ |
| | ROLLERS FOR EMMERGENCY CABIN |
| | (PREFERABLY 8 Nos) |
| 29 | CLADDING |
| 30 | CARRIER BLOCK OR PIPE |
| 31 | CARRIER COUPLING ARM (WITH BEAM) |
| 32 | HYDRAULIC CHAMBER WITH PLUNGER/PISTON |
| 33 | CABLE FOR ACTUATING HYDRAULIC PLUNGER |
| 34 | ARRESTING ROD |
| 35 | LOAD PLATE FULCRUM |
| 36 | BRAKE ARM |
| 37 | RIVET |
| 38 | BRAKE DRUM |
| 39 | BRAKE DRUM COOLER |
| 40 | LOAD PLATE |
| 41 | LOAD PLATE GROOVE |
| 42 | CENTRAL CHAMBER |
| 43 | FLOOR RETRACTOR |
| 44 | FLOOR ROLLERS |
| 45 | FLOOR GUIDE RAIL |
| 46 | FLOOR RETURN SPRING |
| 47 | FLOOR LOCK ANGLE IRON |
| 48 | FLOOR LOCK RETURN SPRING |
| 49 | FLOOR LOCK ACTUATOR |
| 50 | SURFBOARD COUPLING HEAD (SURFBOARD HOOK) |
| 51 | SURFBOARD ROTATION FULCRUM (TILT FULCRUM) |
| 52 | SURFBOARD CENTRAL IRON CORE |
| 53 | LAUNCH (SURFBOARD) SEAT/STRAP POINT |
| 54 | SURFBOARD HAND RAIL |
| 55 | SURFBOARD FOOT REST |
| 56 | SURFBOARD SHIELD |
| 57 | PLASTIC ROLLERS FOR SURFBOARD SLIDE |
| 58 | CARRIER LOAD POINT (SURFBOARD COUPLING |
| | POINT) |
| 59 | SURFBOARD HARNESS |
| 60 | LAUNCH PEDAL |
| 61 | PEDAL LOCK (CATCHER -TYPE) |
| 62 | FULCRUM FOR LAUNCH PEDAL |
| 63 | RETURN SPRING FOR PEDAL RELEASE PUSH ROD |
| 64 | FULCRUM |
| 65 | BEAM LOCK (CATCHER-TYPE) |
| 66 | CATCHER RELEASE PUSH ROD (FOR BEAM LOCK) |
| 67 | CATCHER RELEASE PUSH ROD (FOR PEDAL) |
| 68 | CARRIER/CABIN STACK |
| 69 | LAUNCH PEDAL ROD |
| 70 | CABLE PULLEY |
| 71 | CABLE ANCHORAGE (ON THE LAUNCH COLUMN) |
| 72 | CARRIER IN THE DESCENT MODE |
| 73 | SLIDER |
| 74 | LAUNCH PILLAR GROOVE |
| 75 | SURFBOARD |
| 76 | WINCH POINT |
| 77 | ARRESTING ROD FOR EMERGENCY ESCAPE CABIN |
| 78 | AUXILIARY BRAKE ACTUATOR (ARM) |
| 79 | BRAKE LINING SPRING |
| 80 | BRAKE LINING |
| 81 | SPRING-STOPPER SYSTEM |
| 82 | CATCHER LOCK |
| 83 | CATCHER-RELEASE ACTUATOR (FOR PEDAL) |
| 84 | ESCAPEE |
| 85 | BEAM-CARRIER COUPLING POINT |
| 86 | INTER-CONNECTING METALWORK |
| 87 | “INNER GEARWHEEL” |
| 88 | RETRACTILE FLOOR |
| 89 | FLOOR RETURN SPRING LOAD |
| 90 | ARRESTING CABLE |
| 91 | SLANTING TARPAULIN |
| 92 | TARPAULIN GUIDE SLIT |
| 93 | PEG |
| 94 | PEDAL LOCK POSITION |
| 95 | LOADING HANDLE |
| 96 | PISTON SPRING LOADED CABLE |
| 97 | LOADING PISTON |
| 98 | APERTURE |
| 99 | USED (REUSABLE) CARRIER/RIDE UNITS |
| 100 | EJECTION BLOCK |
| 101 | CROSS PLATE |
| 102 | CABIN HANGER MOUNT |
| 103 | FULCRUM |
| 104 | DOOR-AFFIXED GANGWAY |
| 105 | EMMERGENCY CABIN |
| 106 | RELEASE ARM |
| 107 | FULCRUM |
| 108 | FULCRUM FOR HANGER RELEASE MECHANISM |
| 109 | RELEASE ACTUATOR (FOR SPARE EMERGENCY |
| | ESCAPE CABIN AND CARRIER/RIDE UNIT) |
| 110 | CABIN DOOR |
| 111 | INVERTER BATTERIES |
| 112 | BEDS/SEATS |
| 113 | LIGHT BULB |
| 114 | HANDRAIL |
| 115 | CABINET |
| 116 | TROLLEY/TABLE FOR DEFRIBRILLATOR |
| 117 | OXYGEN CYLINDER |
| 118 | RACK FOR OXYGEN CYLINDERS |
| 119 | FIXED GANGWAY |
| 120 | GROOVE |
| 121 | CARRIER STACK HANGER/CABIN HANGER |
| 122 | SHAFT |
| 123 | CABIN HANGER RETURN SPRING |
| 124 | SHOCK-ABSORBENT GROUND STATION |
| 125 | SOLAR PANELS AND BATTERIES |
| 126 | CARRIER LOADER |
| 127 | RETURN SPRING |
| 128 | CARRIER MAGAZINE (PREFILLED) |
| 129 | LAUNCH BOARD |
| 130 | CARRIER STACK LOCK |
| 131 | RETURN SPRING |
| 132 | DRAW PLATE |
| 133 | SPRING LOADED TWINE |
| 134 | |
| 135 | |
| 136 | CARRIER BLOCK APPENDAGE |
| 137 | STOPPER |
| 138 | CABLE SPRING LOAD |
| 139 | PLATFORM LOCK |
| 140 | CENTER ROD |
| 141 | SPRING |
| 142 | HYDRAULIC LIFTER |
| 143 | ANCHORING PLATE WITH SHIFTING RIVET |
| 144 | MOBILE PLATFORM |
| 145 | CONCRETE PLATFORM |
| 146 | CHAMBERING TABLE |
| 147 | ROLLER |
| 148 | FLOOR-LEVEL (CABIN) CATCHER LEVER |
| 149 | MECHANISM WHEEL |
| 150 | LOCK PIN |
| 151 | CATCHER RETURN SPRING |
| 152 | PISTON GEAR |
| 153 | PISTON-ATTACHED ROLLER BEARING |
| 154 | DRIVE GEARWHEEL WITH PULLEY |
| 155 | DOCKING BOARD |
| 156 | JOINT |
| 157 | FULCRUM |
| 158 | CATCHER RELEASE PUSH ROD |
| 159 | GROOVE AND BOLT |
| 160 | CABLE TO CABIN HANGER CONTROL UNIT (CHCU) |
| 161 | CABIN HANGER SUSPENSION SPRING |
| 162 | BUTTON RETURN SPRING |
| 163 | BRAKE DRUM RELEASE BUTTON |
| 164 | BRAKE DRUM LOCK KNOB |
| 165 | BRAKE POSITIONING SPRING |
| 166 | BRAKE DRUM |
| 167 | GROOVE |
| 168 | GEARWHEEL FULCRUM |
| 169 | PISTON GUIDE RAIL |
| 170 | LOADING HANDLE FULCRUM |
| 171 | PULLEY CABLE ATTACHMENT |
| 172 | PULLEY ROPE |
| 173 | FULCRUM |
| 174 | BRAKE DRUM CATCHER |
| 175 | PUSH RELEASE BUTTON FOR PLATFORM LOCK |
| 176 | RETURN SPRING |
| 177 | CABLE ADJUSTER |
| 178 | DRUM RELEASE CABLE |
| 179 | ADJUSTER CABLE |
| 180 | APERTURE FOR CABLE |
| 181 | CARRIER MAGAZINE FLOOR ROLLERS |
| 182 | DRAW PLATE GUIDE RAIL |

From the foregoing description and drawings, it will be apparent to those skilled in the art that variations and modifications can be made on my invention, without departing from the spirit and scope of it. It is the purpose of the appended claims to cover all such variations and modifications.

I claim:

1. An emergency escape device comprising a launcher on guide rails suspended on a spring loaded cable(s), designed to open a retractile floor for a descending ride unit, the said ride unit conveying person(s), or a load, down the shaft for the purpose of evacuation of a high-rise building or any aloft position in times of need or emergency.

2. An emergency escape system of claim 1 above, comprising floor retractors and floor-lock mechanism for the purpose of safely controlling the movement of the retractile floor, and the locking systemthereto, to be used in a high-rise building for evacuation of persons during fire and other emergencies.

3. An emergency escape system of claim 1 above comprising a launch mechanism that operates on the principle of counterbalancing the opposing force of a spring loaded reel of cable upon which it is hung, and the downward force of the weight of the mechanism, such that any additional weight on the mechanism will result in a downward movement under the effect of gravity.

4. An emergency escape system of claim 1 above, with brake system comprising an arresting appendage or rod which may be retractile in nature and arresting cable(s) that impact the rod during descent and thus, cause a deceleration in the velocity of the ride unit.

5. An emergency escape system of claim 1 above, withtiltable load plate for the purpose of individualizing its brake force.

6. An emergency escape system of claim 1 above, comprising a ride unit mounted on guide rails and engaged with the launcher, and the same can be disengaged from the launcher by a “decoupling” rope or mechanism during the launch mode.

7. An emergency escape system of claim 1 above with an ejection system that does disengage the escapee from the ride unit and while the escapee rolls or slides safely out of the shaft, the ride unit falls off the guide rail onto the ground.

8. An emergency escape systemof claim 1 above with a retractile launch pedal for the purpose of safety, such a pedal being partly controlled by the weight of the escapee on the system.

9. An emergency escape systemof claim 1 above, with a device that works the arresting cable off the arresting appendage/rod for the purpose of avoiding recoil on the ride unit and or to regulate the period of brake action.

10. An emergency escape system of claim 1 above with a chambering mechanism for the purpose of feeding fresh ride units into the system after launch, or while launch is ongoing to prevent ride units on the rack from depleting.

11. A gravity-based emergency escape system comprising a cabin mounted on guide rails for the purpose of evacuating occupants of high-rise abodes, such a cabin having an arresting appendage/rod positioned to impact series of arresting cables placed at intervals across its path of descent, each cable installed with a mechanism to work it off the arresting appendage/rod thereby making the cabin to descend with a substantially constant velocity from the launch station on the skyscraper to the ground station below where it is “ejected” by a mobile platform from the guide rails to clear the way for other descending emergency escape cabins following behind from the launch station.

12. An emergency escape device of claim 1 and claim 11 with self-actuation release system for replenishing the launch station with a ride unit after each launch.

13. An emergency escape device of claim 11 with cabin hanger control system that enables stopover at various floors.

14. An emergency escape device of claim 11 with ride unit-actuated brake system.
